(19) United States
(12) Patent Application Publication
(10) Pub. No.: US 2024/0302648 A1
(43) Pub. Date: Sep. 12, 2024

(54) AN OPTICAL BEAM DIRECTOR

(71) Applicant: BARAJA PTY LTD, North Ryde, New South Wales (AU)

(72) Inventors: Ryan Barnes, North Ryde, New South Wales (AU); Magdalena Meyer, North Ryde, New South Wales (AU); Andrew Bligh, North Ryde, New South Wales (AU); Cibby Pulikkaseril, North Ryde, New South Wales (AU); Jackson Gritching, North Ryde, New South Wales (AU); Federico Collarte Bondy, North Ryde, New South Wales (AU)

(21) Appl. No.: 18/276,386

(22) PCT Filed: Feb. 22, 2022
(86) PCT No.: PCT/AU2022/050135

§ 371 Date: Aug. 8, 2023

(30) Foreign Application Priority Data
Feb. 24, 2021 (AU) 2021900499
Sep. 14, 2021 (AU) 2021902964
Jan. 11, 2022 (AU) 2022900049

(51) Int. Cl. G02B 26/08; G01S 7/481

(52) U.S. Cl. CPC G02B 26/0883; G01S 7/4814

(57) ABSTRACT

An optical beam director is described that include at least one dispersive component configured to receive light and to be rotated about a rotational axis for beam steering in at least one dimension. The at least one dispersive component includes two prisms and the beam director is configured to rotate the two prisms in counter directions and to rotate at least one of the prisms at a variable rate. Spatial estimation systems including the optical beam director and methods of spatial estimation are also described.

### RELATED APPLICATIONS

This application claims priority from Australian patent application numbers 2021900499, 2021902964 and 2022900049. The disclosure of Australian patent application no. 2022900049 is incorporated herein in its entirety.

### FIELD OF THE DISCLOSURE

The present disclosure relates to methods and systems for directing light into multiple directions. More particularly, embodiments of the present disclosure relate to a beam director for use in a LiDAR (light detection and ranging) system.

### BACKGROUND OF THE DISCLOSURE

Optical beam direction has several applications, including but not limited to LiDAR applications, in which light is sent into an environment for mapping purposes. In two or three-dimensional mapping by LiDAR, one of the dimensions relates to the range of a point from the origin of the optical beam, whereas the other one or two dimensions relate to one or two-dimensional space across which the light is directed.

There has recently been substantial interest in the development and use of LiDAR systems, for example for use as an environmental sensor in autonomous vehicles. As in many industries, the size of the components and cost of production are relevant considerations to the design of a LiDAR system, including the beam director, in addition to performance parameters such as the range of operation, resolution and field of view.

### SUMMARY OF THE DISCLOSURE

Aspects of the disclosure relate to an optical beam director including at least one dispersive component configured to receive light and to be rotated about a rotational axis for beam steering in at least one dimension, wherein the at least one dispersive component includes two prisms and the optical beam director is configured to rotate the two prisms in counter directions and configured to rotate at least one of the prisms at a variable rate.

In some embodiments, the optical beam director is configured to rotate at least one of the prisms at a variable rate within a rotation cycle.

In some embodiments, the optical beam director is configured to rotate the at least one of the prisms at a variable rate over a plurality of rotation cycles.

In some embodiments, the optical beam director is configured to stop rotating the prisms at one time and resume rotating the prisms at a later time.

In some embodiments, the optical beam director is configured to rotate the at least one of the prisms faster towards angle(s) that result in the incoming light beam being steered to one or more maximum displacements along a beam steering axis, and/or slower away from such angle(s).

In some embodiments, the two prisms are a Risley prism pair. In some embodiments, the two prisms are rotated at substantially the same rate.

In some embodiments, the two prisms are configured to be rotated in counter directions by a drive system, the drive system including: a first rotating element; at least one second rotating element coupled to the first rotating element to rotate with the first rotating element in a counter direction; a third rotating element configured with a connection to the at least one second rotating element to rotate with the at least one second rotating element in the same direction; a fourth rotating element configured with a connection to the first rotating element to rotate with the first rotating element in the same direction; wherein the third and fourth rotating elements each mount one of the two prisms; and at least one of the rotating elements is configured to receive and rotate responsive to force from a drive source.

In some embodiments, the at least one second rotating element comprises two rotating elements, coupled to the first rotating element by a belt or chain, wherein the belt or chain is configured in a double-sided arrangement to effect the rotation in the counter direction. In some embodiments where the belt is used, the drive system further comprises one or more belt tensioning systems, wherein the one or more belt tensioning systems comprises: a contact pulley for engaging the belt; and a flexible component for tension correction. In some embodiments, the one or more belt tensioning systems are mechanically linked.

In some embodiments, the third and fourth rotating elements mount a prism within a centre void.

In some embodiments, the light includes two or more angularly and/or spatially offset light beams. In some embodiments, the two or more light beams are each directed by the at least one dispersive component across respective portions of a field of view of the optical beam director. In some embodiments, at least two neighbouring respective portions of the field of view overlap with each other.

Aspects of the disclosure relate to a method in a spatial estimation system, the method comprising directing, by a beam director, light into an environment, the directing comprising: spatially directing, by at least one dispersive component, the light in at least one dimension by rotating the at least one dispersive component, wherein the at least one dispersive component includes two prisms and the two prisms are rotated in counter directions, wherein at least one of the prisms is rotated at a variable rate.

In some embodiments, at least one of the prisms is rotated at a variable rate within a rotation cycle. In some embodiments, the at least one of the prisms is rotated at a variable rate over a plurality of rotation cycles.

In some embodiments, rotation of the prisms is stopped at one time and resumed at a later time.

In some embodiments, the at least one of the prisms is rotated faster towards angle(s) that result in the incoming light beam being steered to one or more maximum displacements along a beam steering axis, and/or slower away from such angle(s).

In some embodiments, the two prisms are a Risley prism pair. In some embodiments, the two prisms are rotated at substantially the same rate.

In some embodiments, the two prisms are configured to be rotated in counter directions by a drive system, the drive system including: a first rotating element; at least one second rotating element coupled to the first rotating element to rotate with the first rotating element in a counter direction; a third rotating element configured with a connection to the at least one second rotating element to rotate with the at least one second rotating element in the same direction; a fourth rotating element configured with a connection to the first rotating element to rotate with the first rotating element in the same direction; wherein the third and fourth rotating elements each mount one of the two prisms; and at least one of the rotating elements is rotated by a drive source.

In some embodiments the at least one second rotating element comprises two rotating elements, coupled to the first rotating element by a belt or chain, wherein the belt or chain is configured in a double-sided arrangement to effect the rotation in the counter direction.

In some embodiments where the belt is used, the drive system further comprising one or more belt tensioning systems, wherein the one or more belt tensioning systems comprises: a contact pulley for engaging the belt; and a flexible component for tension correction. In some embodiments, the one or more belt tensioning systems are mechanically linked.

In some embodiments the third and fourth rotating elements mount a prism within a centre void.

In some embodiments, the light includes two or more angularly and/or spatially offset light beams. In some embodiments, the two or more light beams are each directed by the at least one dispersive component across respective portions of a field of view of the optical beam director. In some embodiments, at least two neighbouring respective portions of the field of view overlap with each other.

Aspects of the disclosure relate to a spatial estimation system including a wavelength-tunable light source for generating light and an optical beam director of any one of the beam directors described above for receiving the directing the generated light.

In some embodiments, the wavelength-tunable light source is configured to generate two or more offset light beams. In some embodiments, the two or more offset light beams are spatially offset along a first dimension of a field of view of the optical beam director. In this embodiments, the first dimension of the field of view of the optical beam director is created by rotating the dispersive component that is configured to be rotated.

Aspects of the disclosure relate to a spatial estimation system including a light source, a light receiver and an optical beam director according to an embodiment described in the preceding paragraphs of this summary or according to two or more embodiments described in the preceding paragraphs (where they are not clearly inconsistent with each other) or according to an embodiment described herein with reference to the accompanying drawings.

Further aspects of the present disclosure and further embodiments of the aspects described in the preceding paragraphs will become apparent from the following description, given by way of example and with reference to the accompanying drawings.

### BRIEF DESCRIPTION OF THE DRAWINGS

FIG. 1 illustrates an example arrangement of a spatial profiling system.

FIG. 2 illustrates an example of a light source for the spatial profiling system of FIG. 1.

FIG. 3A illustrates an embodiment of a beam director and FIG. 3B illustrates an embodiment of an optical beam splitter for the beam director.

FIG. 3C illustrates another embodiment of a beam director.

FIG. 3D illustrates another embodiment of a beam director with a single fibre.

FIGS. 4A-C illustrates an exemplary field of view resulting from a beam director arrangement with one, two and three output ports respectively.

FIGS. 5A-B illustrates another exemplary field of view resulting from a beam director arrangement with three and four output ports respectively.

FIG. 6 illustrates another embodiment of a beam director.

FIG. 7 illustrates exemplary first and second dispersive components of the beam director of FIG. 6.

FIG. 7A illustrates how a second prism in a Risley prism pair provides additional beam displacement.

FIG. 7B illustrates a front view of a first embodiment of a drive system for counter-rotating two prisms in the Risley prism pair.

FIG. 7C illustrates a perspective view of the drive system of FIG. 7B.

FIGS. 7D-F illustrate front views of further embodiments of the drive system for counter-rotating two prisms in the Risley prism pair.

FIG. 7G illustrates a front view of another embodiment of the drive system with one or more belt tensioning systems.

FIG. 7H illustrates a front view of another embodiment of the drive system with one or more belt tensioning systems that are mechanically linked.

FIG. 8 illustrates an exemplary simulated ray tracing of light through example components (a collimating element and the first dispersive component including a first prism, a grating and a second prism) from FIG. 6 and FIG. 7 with three output ports each providing light beam at wavelength λ₁, λ₂ and λ₃.

FIG. 9A illustrates an exemplary simulated ray tracing of light through example components (a collimating element, the first dispersive component including a first prism, a grating and a second prism and the second dispersive component including a Risley prism pair rotated at the same rate but in counter direction with three different rotation angles) from FIG. 6 and FIG. 7 with three output ports each providing light beam at wavelength λ₁, λ₂ and λ₃.

FIG. 9B illustrates another exemplary simulated ray tracing similar to the ray tracing of FIG. 9A, but with five different rotation angles.

FIGS. 10(a)-(d) illustrate exemplary overall FOVs at the x-y plane (see FIG. 6 and FIG. 7) at a decreasing distance from the beam director, resulting from rotating the second dispersive component at three different angles.

FIG. 11 illustrates blind spots between the FOVs from neighbouring output ports of FIG. 10(a).

FIGS. 12(a)-(d) illustrate another set of exemplary overall FOVs at the x-y plane at decreasing distanced from the beam director, resulting from rotating the second dispersive component at five different angles.

FIG. 13 illustrates another embodiment of a beam director.

FIGS. 14-16 illustrate exemplary overall FOVs of the beam director of FIG. 13.

FIG. 17 illustrates an exemplary point density comparison between the FOV of FIG. 14 and the FOV of FIG. 16.

### DETAILED DESCRIPTION OF EMBODIMENTS

A beam director for directing light into multiple directions is described. The beam director is suitable for spatial profiling applications, which generate an image, for example a three-dimensional image, of a surrounding environment.

“Light” hereinafter includes electromagnetic radiation having optical frequencies, including far-infrared radiation, infrared radiation, visible radiation and ultraviolet radiation. A spatial profiling system using light may be referred to as a light detection and ranging (LiDAR) system. LiDAR involves transmitting light into the environment and subsequently detecting the light returned by the environment. By determining the time it takes for the light to make a round trip to and from, and hence the distance of, reflecting surfaces within a field of view (FOV), an estimation of the spatial profile of the environment may be formed.

Embodiments of a spatial profiling system including the disclosed optical beam director may be useful in monitoring an environment, including relative movement or change in the environment with respect to the optical beam director. For example, in the field of autonomous vehicles (land, air, water, or space), a spatial profiling system can estimate from the vehicle's perspective a spatial profile of the environment in which the vehicle is to navigate, including the distance to environmental objects, such as an obstacle or a target ahead.

As the vehicle and/or one or more environmental objects move, the spatial profile as viewed from the vehicle may change and may be re-estimated. For example, in an autonomous land vehicle, the estimated spatial profile may include objects such as a road ahead, other vehicles, pedestrians, animals, objects on or near the road and road signs. As another example, in the field of docking, the spatial profiling system can estimate from a container ship's perspective a spatial profile of the dock, such as the proximity of the container ship to particular parts of the dock, to facilitate successful docking. As yet another example, in the field of line-of-sight communication, such as free-space optical or microwave communication, the spatial profiling system may be used for alignment purposes. Where a transceiver in the communication system has moved or is moving, it may be tracked so as to align the optical or microwave beam.

As further examples, the applicable fields for systems including an embodiment of the disclosed beam director include but are not limited to, industrial measurements and automation, site surveying, military, safety monitoring and surveillance, robotics and machine vision, printing, projectors, illumination, attacking and/or flooding and/or jamming other laser and IR vision systems.

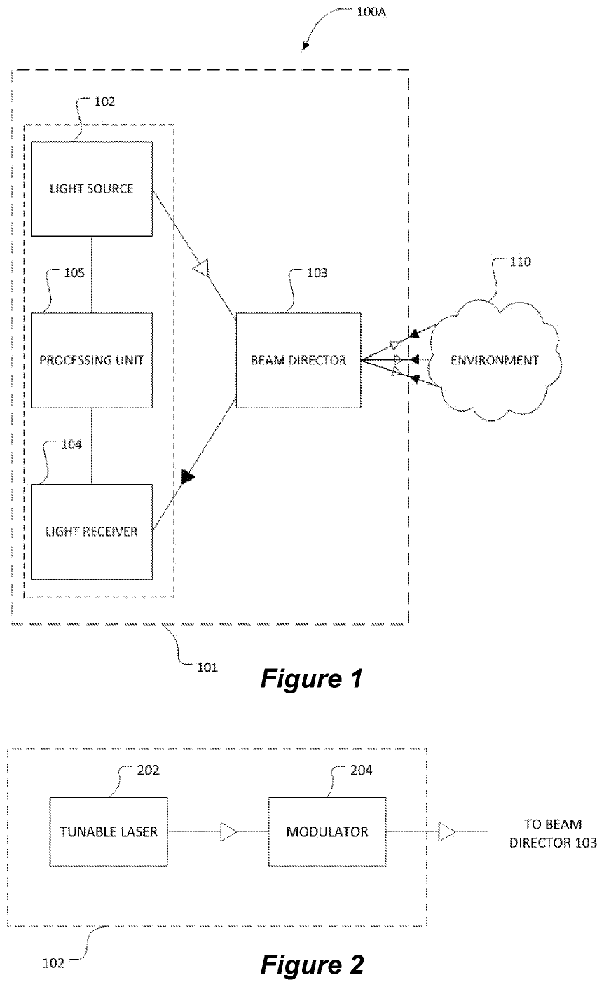

FIG. 1 illustrates an arrangement of a spatial profiling system 100. Further examples and details of a spatial profiling system are provided in international patent publication no. WO 2017/054036 A1 (Baraja Pty Ltd), the entire contents of which are incorporated herein by reference. The system 100 includes a light source 102, a beam director 103, a light receiver 104 and a processing unit 105. In the arrangement of FIG. 1, light from the light source 102 is directed by the beam director 103 in a direction over one or two dimensions (a first and/or a second dimension) into an environment 110 having a spatial profile. If the outgoing light hits an object, at least part of the outgoing light may be reflected (represented in solid arrows), e.g. scattered, by the object back to the beam director 103 and received at the light receiver 104. The processing unit 105 is operatively coupled to the light source 102 for controlling its operations. The processing unit 105 is also operatively coupled to the light receiver 104 for determining the distance to the reflecting surface (a third dimension), by determining the round-trip time for the reflected light to return to the beam director 103.

In some embodiments, the light source 102, the beam director 103, the light receiver 104 and the processing unit 105 are substantially collocated. For instance, in an autonomous vehicle application, the collocation allows these components to be compactly packaged within a single unit 101 within the confines of the vehicle or in a single housing. In other embodiments, the light source 102, the light receiver 104 and the processing unit 105 are substantially collocated within a “central” unit, whereas the beam director 103 is remote from the central unit. In this variant, the central unit is optically coupled to the remote beam director 103 via one or more waveguides, such as optical fibres. In yet another variant, a spatial profiling system may include a single central unit and multiple beam directors. Each of the multiple beam directors may be optically coupled to the central unit via respective waveguides. The multiple beam directors may be placed at different locations and/or orientated with different fields of view (e.g. at the four corners of a vehicle).

FIG. 2 illustrates an arrangement of the light source 102. In this example, the light source 102 may include a wavelength-tunable light source, such as a wavelength-tunable laser diode, providing light of a tunable wavelength based on one or more electrical currents (e.g. the injection current into the into one of more wavelength tuning elements in the laser cavity) applied to the laser diode. The light source 102 accordingly is configured to provide outgoing light at a selected one or more of the multiple wavelength channels (each represented by its respective centre wavelength λ₁, λ₂, . . . λ_{N}). The light source 102 may include a single tunable laser or more than one tunable laser (or other types of lasers). The light source 102 may select one wavelength channel at a time or may simultaneously provide two or more different selected wavelength channels (i.e. channels with different centre wavelengths). In another example, the light source 102 may include a broadband light source and one or more tunable spectral filters to provide substantially continuous-wave (CW) light intensity at the selected wavelength(s). In another example, the light source 102 includes multiple laser diodes, each wavelength-tunable over a respective range and whose respective outputs are combined to form a single output. The respective outputs may be combined using a wavelength combiner, such as an optical splitter or an arrayed waveguide grating (AWG). In one arrangement, the light source 102 is configured to provide the outgoing light to include at least one time-varying profile at the selected one or more of the multiple wavelength channels. The time-varying profile may be used in determining the round trip time of the light. In the example of FIG. 2, the light source 102 includes a modulator 204 for imparting a time-varying profile on the outgoing light. The time varying profile may, for example, be one or more of a variation in intensity, frequency, phase or code imparted to the outgoing light. In some embodiments the light source 102 emits pulses of light, which pulses may include the time-varying profile. In other embodiments the difference between the presence of a pulse and the absence of a pulse is a time varying profile for use in determining the round trip time of light.

In one example, the modulator 204 is a semiconductor optical amplifier (SOA) or a Mach Zehnder modulator integrated on the laser diode. The electrical current applied to the SOA may be varied over time to vary the amplification of the CW light produced by the laser over time, which in turn provide outgoing light with a time-varying intensity profile. In another example, the modulator 204 is an external modulator (such as a Mach Zehnder modulator or an external SOA modulator) to the laser diode. In yet another example, instead of including an integrated or external modulator, the light source 102 includes a laser having a gain medium into which an excitation electrical current is controllably injected for imparting a time-varying intensity profile on the outgoing light.

Where one selected wavelength channel is used at a time, the light receiver 104 may include an avalanche photodiode (APD) that detects any wavelength within the range of the multiple wavelength channels. Where multiple selected wavelength channels are used at a time, the light detector 104 may include a wavelength-sensitive detector system, such as using multiple APDs each dedicated to a specific wavelength channel, or using a single APD for multiple wavelength channels, each channel being distinguishably detectable based on their time-varying attribute (e.g. based on a different sinusoidal modulation such as a modulation frequency of 21 MHz, 22 MHz and 23 MHz . . . corresponding, respectively, to 1550.01, 1550.02 and 1550.03 nm . . . channels).

The operation of the light source 102, such as one or both of the wavelength-tunable laser 202 (e.g. its wavelength) and the modulator 204 (e.g. the modulating waveform), may be controlled by the processing unit 105. The processing unit 105 may be an application specific device configured to perform the operations described herein, such as a configured programmable logic device, or a general purpose computing device with computer readable memory storing instructions to cause the computing device to perform the operations.

In the instance of an application specific device, the instructions and/or data for controlling operation of the processing unit may be in whole or in part implemented by firmware or hardware elements, including configured logic gates. In the instance of a general purpose computing device, the processing unit may include, for example, a single computer processing device (e.g. a central processing unit, graphics processing unit, or other computational device), or may include a plurality of computer processing devices. The processing unit may also include a communications bus in data communication with one or more machine readable storage (memory) devices which store instructions and/or data for controlling aspects of the operation of the processing unit. The memory devices may include system memory (e.g. a BIOS), volatile memory (e.g. random access memory), and non-volatile memory (e.g. one or more hard disk or solid state drives to provide non-transient storage). The operations for spatial profiling are generally controlled by instructions in the non-volatile memory and/or the volatile memory. In addition, the processing unit includes one or more interfaces. The interfaces may include a control interface with the light source 102 and a communication interface with the light receiver 104.

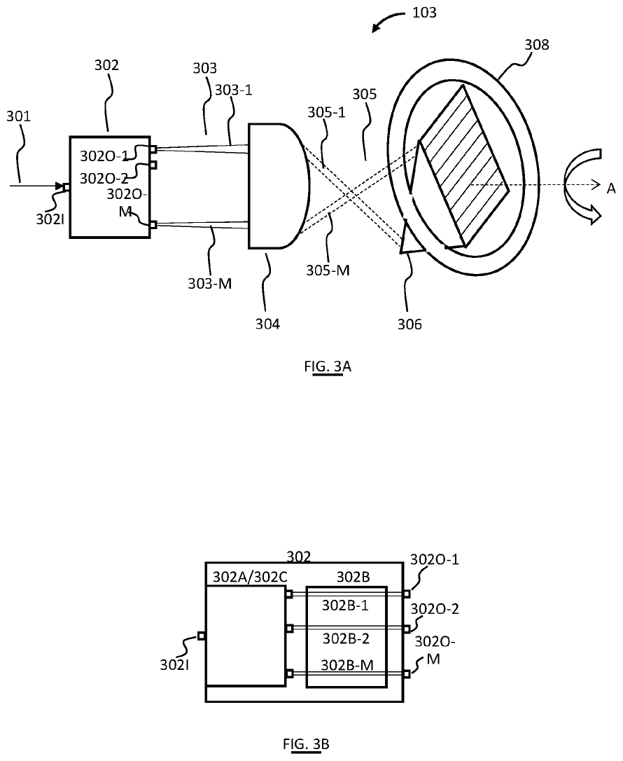

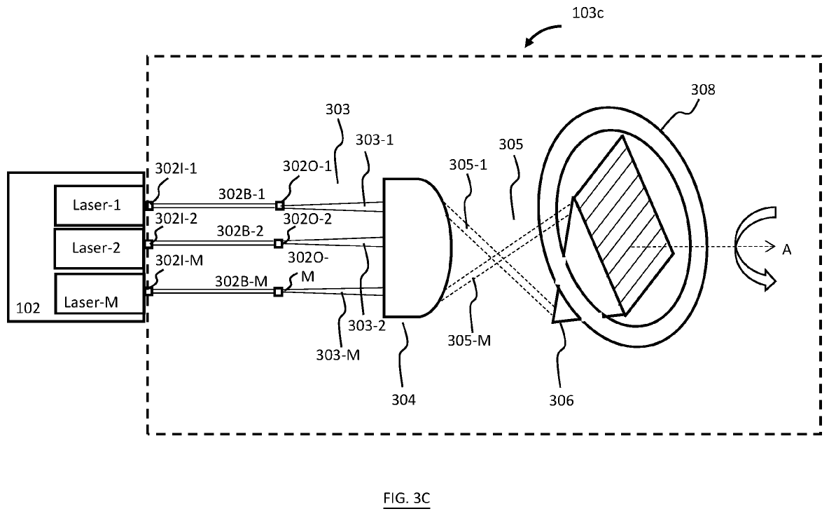

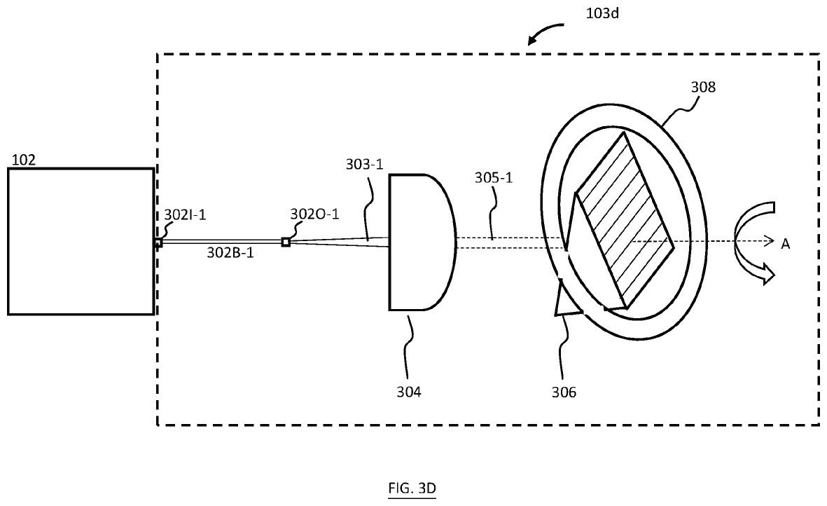

FIG. 3A illustrates an embodiment of a beam director. The following description of the beam director of FIG. 3A is made with reference to its use in the system of FIG. 1. The beam director 103 also has application to other LiDAR systems and to other systems for directing light with different configurations to that shown in FIG. 1.

The beam director 103 receives outgoing light 301, from the light source 120 including wavelength channels λ₁, λ₂, . . . λ_{N}. The beam director 103 may include an optical component 302 having an optical input port 3021 and at least one optical output port (302O-1, 302O-2, . . . , 302O-M, M≥1). Each output port may provide, outgoing light at one wavelength channel only or may provide outgoing light at more than one wavelength channel, for example one wavelength channel at one time period and another wavelength channel at another time period or more than one wavelength channel at a time.

In one example as illustrated in FIG. 3B, the optical component 302 includes an optical beam splitter 302A for splitting the light 301 into more than one outgoing light beam and a fibre array 302B having fibres (302B-1, 302B-2, . . . , 302B-M) for receiving the respective outgoing light beams. Each fibre in the fibre array 302B is, for example, a single mode fibre (SMF), a multi-mode fibre (MMF) or a polarisation maintaining fibre (PMF). The fibres in the fibre array 302B may be the same or different to each other. For example, the fibre array 302B may have four SMFs. In another example, the fibre array 302B may have one MMFs and two SMFs. In yet another example, the fibre array 302B may have one SMF and three PMFs. In another example, also illustrated by FIG. 3B the optical beam splitter 302A is instead an optical switch 302C for sequentially distributing the light 301 through the fibres of the fibre array 302B. The optical switch 302C may be an opto-mechanical switch, an eletro-optic switch or a thermos-optic switch. Output ports of the beam director 103, which may be for example the ends of optical fibres, are referenced 302O-1, 302O-2, . . . , 302O-M. In yet another example, the optical component 302 includes a wavelength router (e.g. an optical interleaver or demultiplexer) instead of a beam splitter or switch. Expanding light 303 having multiple beams (303-1, . . . , 303-M) over free space, each from one of the output ports 302O-1, 302O-2, . . . , 302O-M, is received by at least one collimating element 304 for producing corresponding collimated light 305 having multiple beams (305-1, . . . , 305-M) each corresponding to one of the expanding beams 303-1, . . . , 303-M. In one example, the at least one collimating element 304 includes a collimating lens. The collimating element 304 as shown is for illustrative purposes only. The shape and refractive index of the collimating element 304 is selected to achieve collimation of each beam in the light 303 and may or may not scale and/or invert the image of the light 303. The collimated light 305 is received by a dispersive element 306 for steering the collimated light 305 in multiple directions based on wavelengths over a first dimension (which may be called “the wavelength dimension”). In one embodiment, the dispersive element 306 includes a prism, a diffractive grating or a combination of the prism and the diffractive grating. The combination of the prism and the diffractive grating may include two separate elements (i.e. a prism and a diffractive grating) or a single element, such as a grism. As one example, the grism is a silica grism. As another example, the grism is a silicon grism. A silicon grism may provide a higher degree of dispersion than a silica grism. In another embodiment, the dispersive element 306 is a meta-optics element made from a metamaterial. The dispersive element 306 can be designed to be direct vision, so light at a designated wavelength (e.g. at or near the centre wavelength) enters and exits the dispersive element 306 at substantially the same angle. That is, at the designated wavelength, the light beam entering the dispersive element 306 is substantially coaxial (with or without a lateral displacement) with the corresponding light beam exiting the dispersive element 306.

FIG. 3C illustrates another embodiment of a beam director 103c. In FIG. 3C like components and features of the beam director 103c to the beam director described with reference to FIGS. 3A and 3B are shown with like reference numerals. The beam director 103c is different from the beam director described in FIGS. 3A and 3B in that the beam director 103c includes at least one fibre (302B-1, 302B-2, . . . , 302B-M, M≥1) without an optical beam splitter or optical switch, one end of each fibre (302I-1, 302I-2, . . . , 302I-M, M≥1) being connected to a respective laser (Laser-1, Laser-2, . . . , Laser-M) in the light source 102. The light source 102 may select one wavelength channel at a time for each laser (Laser-1, Laser-2, . . . , Laser-M) or may simultaneously activate two or more lasers each providing a selected wavelength channels. The selected wavelength channels for each laser in the light source 102 may be the same or different. The other end of each fibre serves as an output port (302O-1, 302O-2, . . . , 302O-M, M≥1) and outputs expanding light 303-1, 303-2, . . . , 303-M, respectively to at least one collimating element 304 for producing corresponding collimated light 305 having multiple beams (305-1, . . . , 305-M) each corresponding to one of the expanding beams 303-1, . . . , 303-M. The collimating light 305 is then received by a dispersive element 306.

In another embodiment, the optical component 302 or the combination of laser and fibre arrays (i.e. the combination of the light source 102 including one or more lasers and at least one fibres) may be replaced by at least one vertical-cavity surface-emitting laser (VCSEL). Two or more VCSELs may be formed as a VCSEL array. Each output of the VCSELs on the VCSEL array serves as an output port (302O-1, 302O-2, . . . , 302O-M, M≥1) and outputs expanding light 303-1, 303-2, . . . , 303-M, respectively to at least one collimating element 304 for producing corresponding collimated light 305 having multiple beams (305-1, . . . , 305-M) each corresponding to one of the expanding beams 303-1, . . . , 303-M. The collimating light 305 is then received by a dispersive element 306.

As illustrated in FIGS. 3A and 3C where multiple beams are received by the collimating element 304, the collimating element 304 changes transmission directions of the beams that do not travel along the axis of the collimating element 304.

FIG. 3D illustrate another embodiment of a beam director 103d. In FIG. 3D like components and features of the beam director 103d to the beam director described with reference to FIGS. 3A and 3B are shown with like reference numerals. The beam director 103d includes a single fibre 302B-1 (i.e. M=1) receiving light at one end 302I-1 from the light source and outputs expanding light 303-1 at the other end 302O-1 to at least one collimating element 304. The at least one collimating element 304 then produces collimating light 305-1 to a dispersive element 306. As illustrated in FIG. 3D where the light beam 303-1 travels along the axis of the collimating element 304, the collimating element 304 does not change the transmission direction of the beam 303-1 producing the collimating light 305-1 at the same direction as the beam 303-1.

The dispersive element 306 is rotated, for example about an axis A shown in FIG. 3A, for steering the outgoing light over a second dimension (which may be called “the mechanical dimension”) throughout a rotation cycle. Where the dispersive element 306 includes a diffraction grating, the dispersive element 306 is rotated about an axis substantially orthogonal to the grating lines. The wavelength dimension and the mechanical dimension include components that are substantially orthogonal. The wavelength dimension and the mechanical dimension may be represented in Cartesian (x, y) or polar (r, phi) coordinates. The rotation may be, for example, by an electric motor that is mechanically or electromechanically connected to a housing of the dispersive element 306. In one example, rotating the dispersive element 306 may be realised by placing the dispersive element 306 in a hollow-core motor 308. The dispersive element 306 may be oriented in the hollow-core motor to maintain its direct-vision configuration upon rotation. That is, as discussed above, light at a designated wavelength (e.g. at or near the centre wavelength) incident the dispersive element 306 is substantially coaxial (with or without a lateral displacement) with the corresponding light beam exiting the dispersive element 306 regardless of the rotation of the dispersive element 306. Such substantial coaxial configuration may support a synergy in combining the direct-vision dispersive element 306 with the hollow-core motor 308 in a compact footprint. For the purposes of the present disclosure, referring to “rotation”, “rotated”, “rotating” or similar includes any form of angular adjustment and includes but is not limited to elements that are constantly or continuously rotating and to elements that are rotated through a full 360 degrees.

The dispersive element 306 may be rotated at either a constant or a variable speed within the rotation cycle. For example, the dispersive element 306 is rotated more slowly during an “on” portion in a duty cycle and faster during an “off” portion in the duty cycle. In case of the dispersive element 306 being a diffraction grating or grism, diffraction efficiencies change with rotation of the dispersive element 306. The “on” portion in the duty cycle here is defined by a rotational range that the dispersive element 306 is able to diffract light beyond a diffraction threshold into the operating FOV. The diffraction threshold may correspond to one or more specific conditions. In one arrangement, the diffraction threshold corresponds to a non-diffracting condition. In another arrangement, the diffraction threshold corresponds to a minimum set of metrics, such as one or more of (a) a minimum required FOV and/or (b) a minimum required output optical power.

For example, the diffraction threshold may correspond to light being directed with output optical power to detect a range over 300 meters in the field of view of +/−30 degrees in the horizontal axis and +/−30 degrees in the vertical axis. The “off” portion in the duty cycle here is defined as the portion other than the “on” portion in the duty cycle.

It will be appreciated that rotating the dispersive element 306 in a variable speed may reduce the non-operational time and/or provide a denser point cloud (i.e. a better resolution). A point cloud, as an output from one scan provided by the spatial profiling system 100, is a set of data points in space, where each data point represents an optically reflective surface of an obstacle encountered by outgoing light transmitted by the spatial profiling arrangement 100 into the environment. The point cloud can be produced by the processing unit 105 of the spatial profiling system 100 based on the reflected light received at the light detector 104.

Further discussion of a duty cycle of a dispersive element, including methods and systems for increasing the duty cycle (e.g. towards 100% duty cycle) are described in international patent publication number WO 2019/241825 λ1 (Baraja Pty Ltd), the entire contents of which are herein incorporated by reference. For example, the duty cycle may be increased by using one or more additional rotating dispersive elements (e.g. grism, grating or meta-optics element, which may or may not be the same dispersive element as the dispersive element 306), with angularly offset diffractive axes relative to the diffraction axis of dispersive element 306. All the dispersive elements are configured to co-rotate (i.e. at the same speed and same rotation direction) about a common rotational axis perpendicular to the diffraction axes of the dispersive elements. In one example, an acquisition period is set as 2 μs, which allows 300-metre LiDAR detection range (600 metres of round trip) and 500,000 points within the FOV provided by one output port in a second in the spatial profiling system 100.

In other examples, the dispersive element 306 may be rotated at either a constant or a variable rate over several rotation cycles.

As a result, the outgoing light from the light source 102 is steered by the beam director 103 into multiple directions over two dimensions (i.e. wavelength dimension and mechanical dimension) into the environment 110 having a spatial profile. At least part of the outgoing light may be reflected back to the beam director after hitting an object such as a reflecting surface in the environment. The reflected light may share a substantial coaxial path with the outgoing light and a determined return time is indicative of a third dimension in the environment 110. The aperture of the dispersive element 306 may be selected based on characteristics including the power of the outgoing light, the receiver sensitivity and the LiDAR range. For example, given a light beam typically diverges over distance, a larger range corresponds to a selection of a larger aperture for capturing a diverging return light beam.

Using a grism for directing light across the wavelength dimension may provide a higher degree of dispersion for a particular light beam, compared to using a single grating with the same grating period, and hence greater angular separation of differently directed light beams in a wavelength channel. Additional dispersion may be provided by adding another dispersive element, e.g. a prism, after the grating. However, the first dispersive element changes the transmission direction of the incident light. The subsequent dispersive element is therefore required to be placed off-axis in relation to the first dispersive element. Accordingly, this off-axis placement increases the size of the beam director. In this regard, it will be appreciated that configurations which allow light to stay substantially undeviated (possibly with some lateral displacement), so that subsequent components can be placed on-axis (i.e. substantially along the axis of the first dispersive element) may result in a reduced footprint of the beam director and the system that the beam director is placed in.

Each of the output ports 302O-1, 302O-2, . . . , 302O-M may provide an outgoing light beam at one or more wavelength channels, either sequentially or simultaneously. The beam director 103 may be configured to provide a X-degree FOV over a certain wavelength tuning range for each output port, for example, a 10-degree FOV (X=10) over a 40-nm wavelength tuning range (about 1520 nm to about 1560 nm). While the examples and calculations in this description are based on each output port providing the same FOV, a person skilled in the art would appreciate that the system may be adapted so that the FOV provided by each output port is not the same. For cases where one output port provides the outgoing beam at more than one wavelength channel, the output port transmits and receives light beams in different wavelength-dependent directions at the same time whereas the received reflected light can be spectrally resolved and detected, for example, with assistance of a tunable spectral filter before the light detector 104. Alternatively or additionally, each of the output ports 302O-1, 302O-2, . . . , 302O-M may be offset from neighbouring outputs, which causes corresponding collimated light beams (305-1, . . . , 305-M) to be angularly offset, to provide a larger overall FOV (about M×X-degree with substantially no overlapping between neighbouring outgoing light beams, about (M×X−(M−1)×Y)-degree FOV with about Y-degree overlapping between neighbouring collimated light beams 305 for avoiding blind spots) or a denser point cloud (i.e. a better resolution). It will be appreciated that an odd number of the output ports (i.e. M being an odd number) may allow one of the output ports to centre on the overall FOV.

In one example, there are three output ports (i.e. M=3) each providing a 10-degree FOV (i.e. X=10) with the centre output port providing an outgoing light beam at two different wavelength channels at any one time and the other two output ports each providing an outgoing light beam at one wavelength channel at any one time. With rotation of the dispersive element 306, the beam director in this example is able to cover 30 degrees in a horizontal axis (30-degree HFOV) and 30 degrees in a vertical axis (30-degree VFOV). With a 2-μs acquisition period, this configuration may achieve a high resolution of 1.5 million points per second at the 30/30-degree FOV (i.e. 30-degree HFOV and 30-degree VFOV). In another example, there are four output ports (i.e. M=4) each providing an outgoing light beam at one wavelength channel at any one time with a 10-degree FOV (i.e. X=10) and a 3-degree overlap between neighbouring outgoing light beams, for avoiding blind sports (i.e. Y=3). As a result, the beam director in this example is able to cover an overall 31-degree HFOV and 31-degree VFOV with rotating the dispersive element 306 at a 100% duty cycle. With the 2-μs acquisition period, this configuration may achieve a high resolution of 2 million points per second at the 31/31-degree FOV (i.e. 31-degree HFOV and 31-degree VFOV). A person skilled in the art would also appreciate that a different overall FOV is achievable by using the described beam director 103 and adjusting the variables such as the period of the dispersive element 306, wavelength tuning range of each output port, X, Y and/or M. The configuration using three output ports with the centre output port having dual wavelength channels may allow averaging-based increased receiver sensitivity, which in turn provides additional LiDAR detection range. For example, the processing unit 105 may average 4 measurements which are obtained from 2 wavelength channels in each of 2 time slots in one acquisition period to provide a 3 dB increase in receiver sensitivity and consequently about 50-80 metre additional LiDAR detection range.

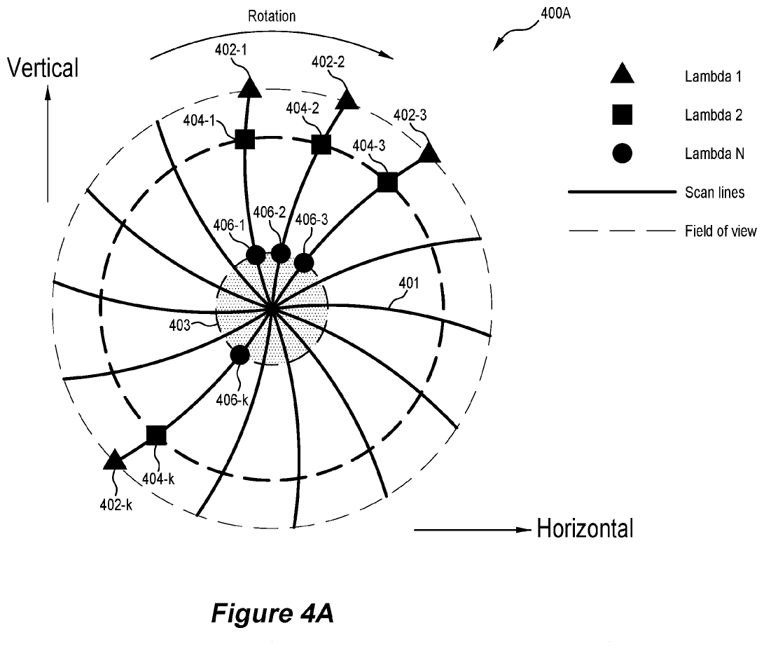

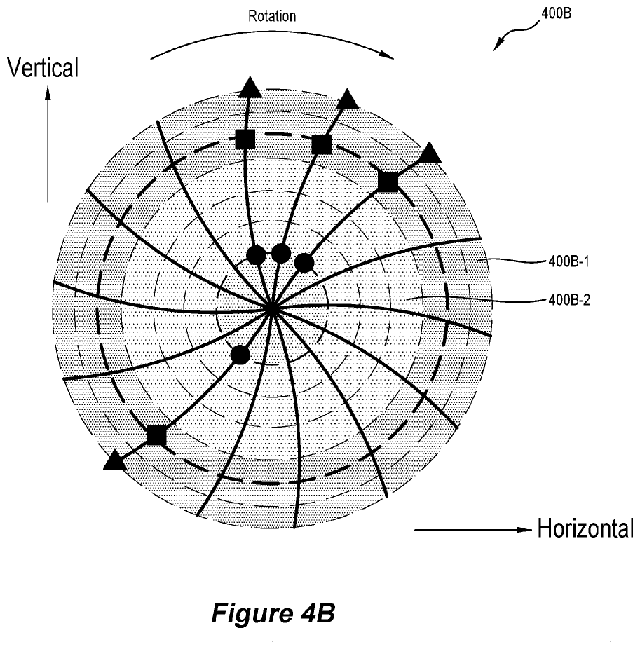

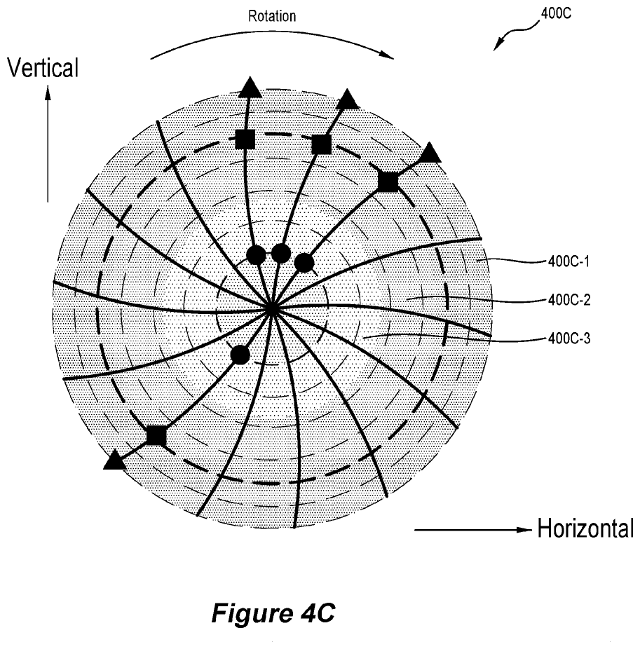

FIG. 4A illustrates an exemplary FOV 400A resulting from rotating the dispersive element 306 with one output port providing the outgoing light beam at wavelength λ₁, λ₂, . . . , λ_{N} in the beam director 103 operated at 100% duty cycle. The wavelength λ₁, λ₂, . . . , λ_{N} is swept in a repeated sequence (i.e. in a sequence of λ₁, λ₂, . . . , λ_{N}, λ₁, λ₂, . . . λ_{N}, λ₁, λ₂, . . . λ_{N}, . . . ). The resultant FOV is substantially circular and is made up of individual points/pixels 402-1, 402-2, 402-3, . . . , 402-k, . . . (provided by λ₁), 404-1, 404-2, 404-3, . . . , 404-k, . . . (provided by λ₂), . . . , 406-1, 406-2, 406-3, . . . , 406-k, . . . (provided by λ_{N}), each of which represents a direction in which the outgoing light beam is steered. In this example as illustrated in FIG. 4A, scan lines 401 form a “near-radii” pattern in which a full wavelength sweep directs the outgoing beam from the FOV perimeter (λ₁) approaching the centre of the FOV (λ_{N}) to cover a full radius as the dispersive element rotates. In another example, the scan lines 401 may form a “near-diameters” pattern in which the full wavelength sweep directs the outgoing beam from one side of the FOV perimeter to the other side of the FOV perimeter via the centre of the FOV if the direction corresponding to the centre frequency in the outgoing beam is aligned with the rotational axis.

In one example, beam steering is quicker along the wavelength dimension (so-called “fast axis”) than along the mechanical dimension (so-called “slow axis”). For example, a rotation frequency may be less than 40 Hz (i.e. time for a rotation cycle longer than 25 ms) whereas time for sweeping wavelengths across a radius may be less than 130 μs with a 2-μs acquisition period (i.e. 500,000 points per second or 12,500 points per rotation cycle, which if evenly distributed in a circular FOV form a circle of 63-point radius, which in turn takes 126 μs to scan across). FIG. 4A illustrates an exemplary FOV 400A resulting from one output port only. In another example as illustrated in FIG. 4B, a FOV 400B resulting from two output ports may be similar, with the outgoing light beam from the first output port covering an outer radius portion (400B-1) and the outgoing light beam from the second output port covering an inner radius portion (400B-2). In one example each output port covers about half the radius of the FOV. In other examples one output port covers a larger radius than the other, with the same or with different pixel resolutions between the ports. Similarly, in yet another example as illustrated in FIG. 4C, a FOV resulting from 3 output ports may have the outgoing light beam from the first output port covering an outer radius portion (400C-1), the outgoing light beam from the second output port covering a middle radius portion (400C-2) and the outgoing light beam from the third output port covering an inner radius portion (400C-3). As with the two output port example, the coverage of each radius portion may be about one third, or in other selected proportions. The pixel resolution may also be the same or different between any two of the three portions. In this regard, the FOV for more output ports can be envisaged.

As illustrated in FIGS. 4A-4C, the mechanical dimension distributes pixels around concentric circles while the wavelength dimension distributes pixels across a radius of the relevant concentric circle. In the examples as illustrated in FIGS. 4B and 4C, the beam director may direct light over a band of circles achieving an annular FOV through an optical output port of the optical component 302 (e.g. 400B-1, 400C-1 or 400C-2). FIG. 4B illustrates one annular FOV 400B-1 provided by one optical output port. FIG. 4C illustrates two annular FOVs 400C-1 and 400C-2 provided by two offset optical output ports to form a larger FOV while maintaining resolution. The curvature of the scan lines may be limited by changing the wavelength of the outgoing light beam relatively quickly in relation to the rate of rotation of the dispersive element 306. It will be appreciated that the scan lines may be straightened if the wavelength is changed more quickly and/or the dispersive element 306 is rotated more slowly.

The inventors also recognise that such FOV provided by the beam director 103 as for example illustrated in FIG. 4A provides a natural foveation 403 towards the centre of the FOV if the wavelength is changed linearly. Foveation in the context of a LiDAR system refers to the ability to be controlled to exhibit differential temporal resolution and/or to exhibit differential angular resolution in different regions of the FOV. For example, if a fast moving and/or distant object is detected, an ability of the system to foveate on that object (e.g. by using increased point density within a region at the object relative to a region not at the object) may be advantageous. It will be appreciated that the foveation 403 may be increased or decreased if the wavelength is changed nonlinearly.

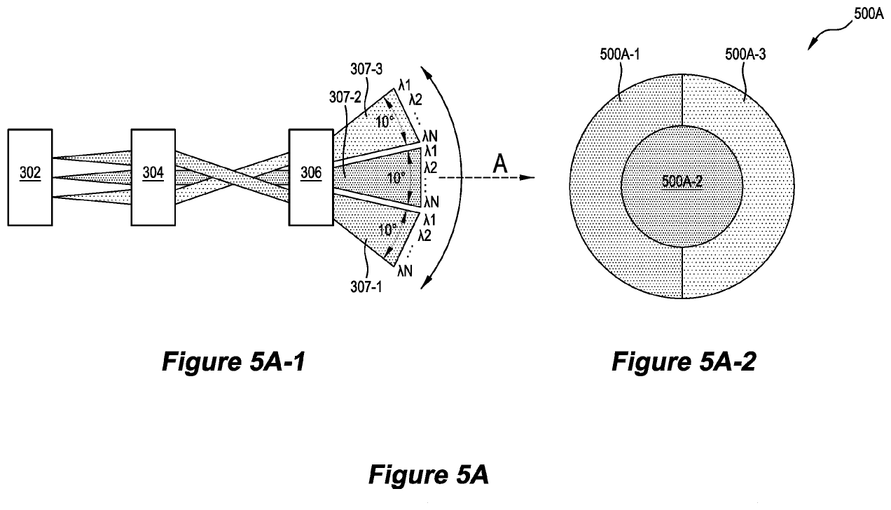

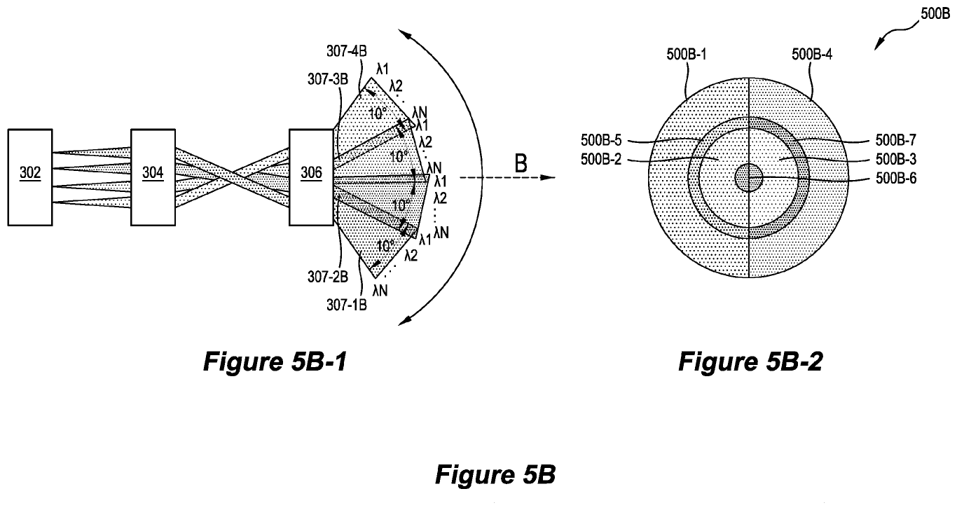

FIG. 5A illustrates another exemplary FOV resulting from a beam director arrangement with three output ports. The beam director arrangement with three output ports is illustrated in FIG. 5A-1. The beam director includes an optical component 302, at least one collimating element 304 and at least one dispersive element 306, according to any embodiment described herein. For example, the at least one dispersive element 306 may include a grism or a meta-optics element.

In the example each output port provides a 10-degree FOV. The beam director in this example is able to cover 30 degrees in a horizontal axis (30-degree HFOV) and 30 degrees in a vertical axis (30-degree VFOV). In other embodiments one or more of the output ports may provide a different FOV and the total field of view may also differ.

In this embodiment, light corresponding to the centre frequency in outgoing beam 307-2 provided by the centre output port is directed to be substantially aligned with the rotational axis A. Outgoing beams 307-1 and 307-3 provided by the other two peripheral output ports are also in this embodiment substantially symmetrical to each other with respect to the rotational axis A. Further, the dispersive element 306 may be designed to be direct-vision, so that light corresponding to a designated wavelength (e.g. at or near the centre wavelength) in one or more of outgoing beams 307-1, 307-2 and 307-3 is directed to enter and exit the dispersive element 306 at substantially the same angle, That is, at the designated wavelength, the light beam entering the dispersive element 306 is substantially coaxial (with or without a lateral displacement) with the corresponding light beam exiting the dispersive element 306. Other embodiments may include asymmetrical arrangements for the centre output port and/or peripheral output ports.

FIG. 5A-2 illustrates an exemplary FOV 500A resulting from rotating the dispersive element 306 about the rotational axis A for a full rotation in the beam director arrangement as illustrated in FIG. 5A-1. The exemplary FOV 500A illustrates the case of the dispersive element 306 operating at 100% duty cycle. The outgoing beam 307-2 covers a centre circular FOV 500A-2 (i.e. a near-diameters FOV), whereas the outgoing beams 307-1 and 307-3 each cover an annular FOV (500A-1, 500A-3) (i.e. a near-radii FOV).

Although depicted as a sharp transition in FIG. 5A-2, the FOV 500A-1 may overlap with the FOV 500A-3. Similarly, the near-diameters FOV may overlap with the near-radii FOV. In some embodiments a spatial profiling system may utilise the overlapped portions to assist in determining the overall field of view and/or for tracking objects moving across the field of view, for example by matching like detected environmental features across two overlapping fields of view.

FIG. 5B illustrates another exemplary FOV resulting from a beam director arrangement with four output ports. The beam director arrangement with four output ports is illustrated in FIG. 5B-1. Like reference numerals are used for like components between FIGS. 5A and 5B.

Each output port provides a 10-degree FOV, in this case with a 3-degree overlap between neighbouring outgoing beams (i.e. 3-degree overlap between outgoing beams 307-1B and 307-2B, 3-degree overlap between outgoing beams 307-2B and 307-3B, 3-degree overlap between outgoing beams 307-3B and 307-4B). The angular extent of each field of view and/or the extent of the overlap may differ in other embodiments.

In this embodiment, the outgoing beams 307-1B and 307-4B are substantially symmetrical to each other with respect to the rotational axis B. The outgoing beams 307-2B and 307-3B are substantially symmetrical to each other with respect to the rotational axis B. Further, the dispersive element 306 may be designated to be direct-vision, so that light at a designated wavelength (e.g. at or near the centre wavelength) in one or more of the outgoing beams 307-1B, 307-2B, 307-3B and 307-4B is directed to enter and exit the dispersive element 306 at substantially the same angle. That is, at the designated wavelength, the light beam entering the dispersive element 306 is substantially coaxial (with or without a lateral displacement) with the corresponding light beam exiting the dispersive element 306.

FIG. 5B-2 illustrates an exemplary FOV 500B resulting from rotating the dispersive element 306 about the rotational axis B for a full rotation in the beam director arrangement as illustrated in FIG. 5B-1. The exemplary FOV 500B illustrates the case of dispersive element 306 operating at 100% duty cycle. Each of the outgoing beams 307-1B, 307-2B, 307-3B and 307-4B covers an annular FOV (500B-1, 500B-2, 500B-3, 500B-4) (i.e. near-radii FOV), respectively.

The overlap between neighbouring outgoing beams result in FOVs 500B-5, 500B-6 and 500B-7. The FOV 500B-1 may be overlapped with the FOV 500B-4 while the FOV 500B-2 may be overlapped with the FOV 500B-3. The beam director in this example covers 31 degrees in a horizontal axis (31-degree HFOV) and 31 degrees in a vertical axis (31-degree VFOV). The exemplary FOVs in FIGS. 5A-2 and 5B-2 illustrate the case of the dispersive element operating at 100% duty cycle, where each full rotation of the dispersive element 306 corresponds to distribution of points/pixels over the full 360-degree azimuthal extent of the field of view. A skilled person would appreciate that, in practice, a duty cycle less than 100% may be used, which corresponds to distribution of points/pixels over less than the full 360-degrees azimuthal extent of the field of view. For example, a full rotation of a dispersive element operating at 80% duty cycle corresponds to distribution of points/pixels over an azimuth of 288 degrees.

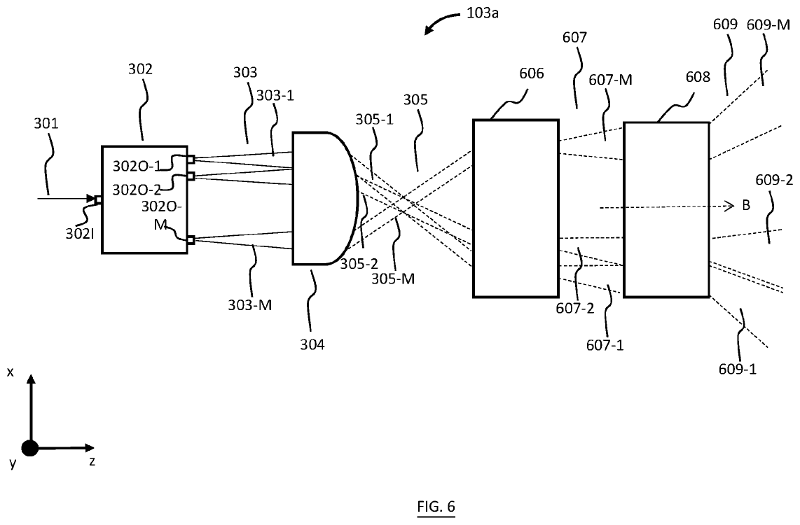

FIG. 6 illustrates another embodiment of a beam director 103a. In FIG. 6 like components and features of the beam director 103a to the beam director described with reference to FIGS. 3A and 3B are shown with like reference numerals. The following description of the beam director of FIG. 6 is made with reference to its use in the system of FIG. 1. In particular, the beam director 103 of FIG. 1 may be the beam director 103a. The beam director 103a also has application to other LiDAR systems and to other systems for directing light with different configurations to that shown in FIG. 1.

The beam director 103a receives outgoing light 301, from the light source 120 including wavelength channels λ₁, λ₂, . . . λ_{N}. The beam director 103 includes an optical component 302 having an optical input port 3021 and at least one optical output port (302O-1, 302O-2, . . . , 302O-M, M≥1). In embodiments with more than one output port, each output port may provide outgoing light at one wavelength channel only or may provide outgoing light at more than one wavelength channel, for example one wavelength channel at one time period and another wavelength channel at another time period or more than one wavelength channel at a time. Example embodiments of the optical component 302 of FIG. 6 is described herein with reference to FIG. 3B.

In another embodiment (not shown), the beam director includes at least one fibre (302B-1, 302B-2, . . . , 302B-M, M≥1) without an optical beam splitter or optical switch, one end of each fibre (302I-1, 302I-2, . . . , 302I-M, M≥1) being connected to a respective laser in the light source 102. The light source 102 may select one wavelength channel at a time for each laser or may simultaneously activate two or more lasers each providing a selected wavelength channels. The selected wavelength channels for each laser in the light source 102 may be the same or different. The other end of each fibre serves as an output port (302O-1, 302O-2, . . . , 302O-M, M≥1) and outputs expanding light beams 303-1, 303-2, . . . , 303-M (collectively 303), respectively.

The expanding light 303 having multiple beams (303-1, . . . , 303-M) over free space, each from one of the output ports 302O-1, 302O-2, . . . , 302O-M, is received by at least one collimating element 304 for producing corresponding collimated light 305 having multiple beams (305-1, . . . , 305-M) each corresponding to one of the expanding beams 303-1, . . . , 303-M. In one example, the at least one collimating element 304 includes a collimating lens. The collimating element 304 as shown is for illustrative purposes only. The shape and refractive index of the collimating element 304 is selected to achieve collimation of each beam in the light 303 and may or may not scale and/or invert the image of the light 303. As illustrated in FIG. 6 where multiple beams are received by the collimating element 304, the collimating element 304 changes transmission directions of the beams that do not travel along the axis of the collimating element 304. The collimated light 305 is received by a first dispersive component 606 for steering the collimated light 305 in multiple directions based on wavelength over a first dimension (which may be called “the wavelength dimension”). The first dispersive component 606 may be static or not rotated like the dispersive element 306 of FIG. 3A. It will be appreciated that the static first dispersive component 606 may improve alignment tolerance compared with a rotating dispersive component 606, as the different light beams 305-1, 305-2, . . . , 305-M enter the dispersive component 606 at different angles, while the rotation axis (if the dispersive component 606 is rotated) can only be aligned with at most one of the light beams 305-1, 305-2, . . . , 305-M.

The first dispersive component 606 is followed by a second dispersive component 608. The second dispersive component 608 is rotated, for steering the outgoing light over a second dimension (which may be called “the mechanical dimension”) throughout a rotation cycle. For example, the second dispersive component 608 may be rotated about an axis B extending substantially through the optical axis of the second dispersive component 608, as shown in FIG. 6. In other embodiments the rotation axis may be offset from the optical axis.

The wavelength dimension and the mechanical dimension include components that are substantially orthogonal. The wavelength dimension and the mechanical dimension may be represented in Cartesian (x, y) or polar (r, phi) coordinates. The rotation may be, for example, by an electric motor that is mechanically or electromechanically connected to a housing of the dispersive element 608. In one example, rotating the dispersive element 608 may be realised by placing the dispersive element 608 in a hollow-core motor (not shown). The rotational axis of the hollow-core motor may be substantially aligned with the rotation axis of the dispersive element 608. Such substantial alignment may support a synergy in combining the dispersive element 608 with the hollow-core motor in a compact footprint. In one example, beam steering is quicker along the wavelength dimension (so-called “fast axis”) than along the mechanical dimension (so-called “slow axis”).

As noted, the figures are shown for illustrative purposes only and may not be in scale. For example, the output ports 302O-1, 302O-2, . . . , 302O-M may be positioned close to each other such that the beams 305-1, 305-2, . . . , 305-M in some extent or largely overlap with each other and/or that beams 607-1, 607-2, . . . , 607-M (collectively 607) in some extent or largely overlap with each other. The separation distance between neighbouring output ports 302O-1, 302O-2, . . . , 302O-M may be adjusted such that the adjacent outgoing light beams 609-1, 609-2, . . . , 609-M (collectively 609) overlap for avoiding blind spots.

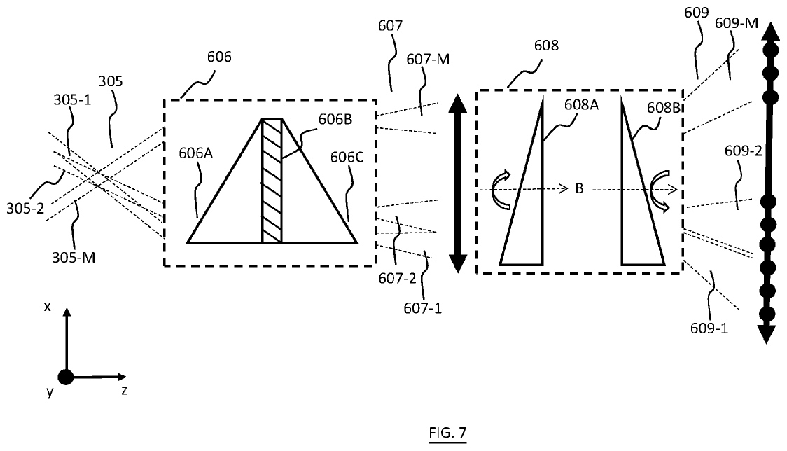

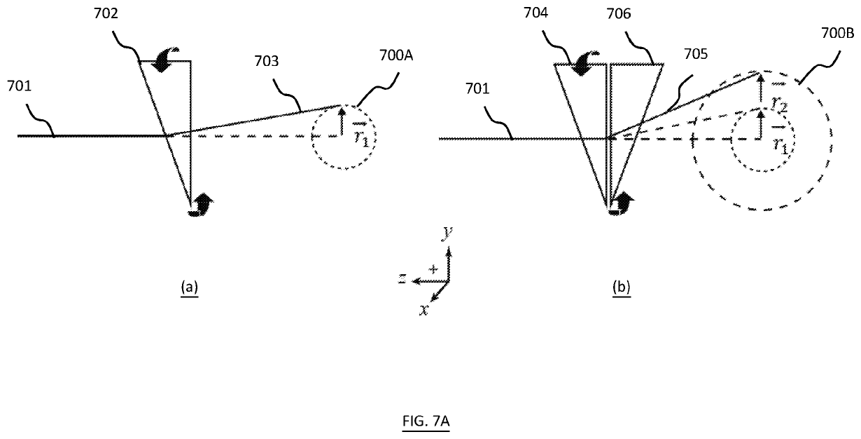

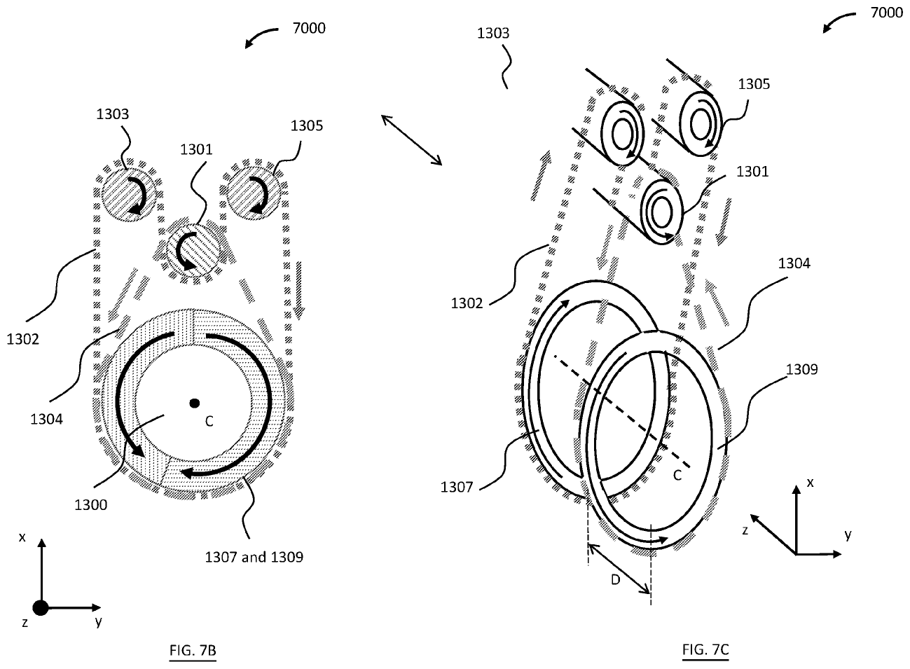

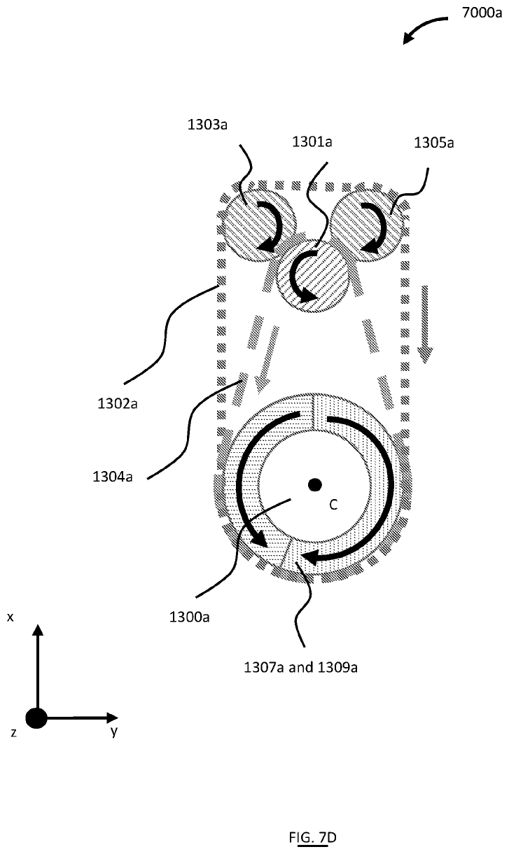

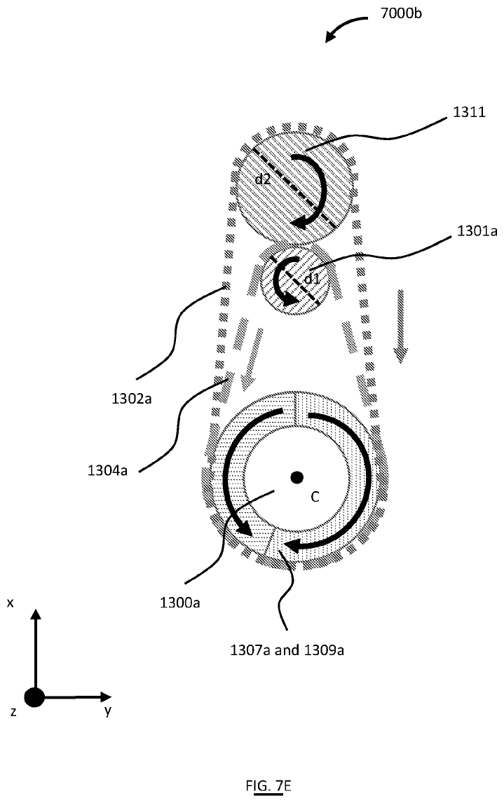

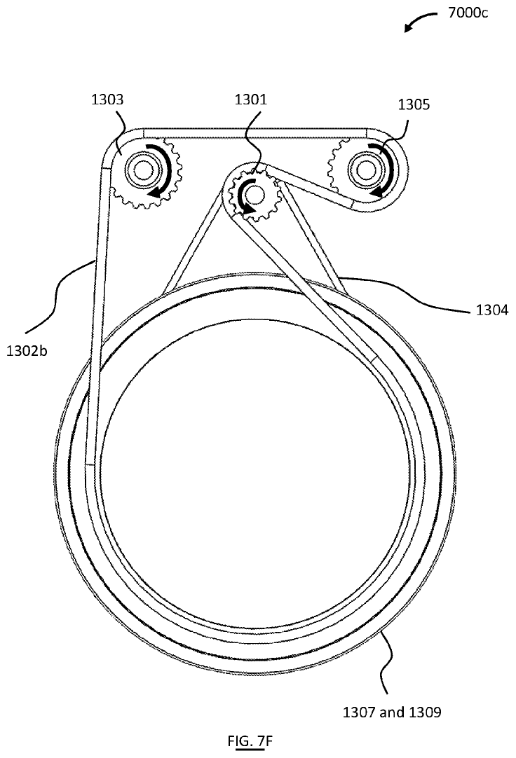

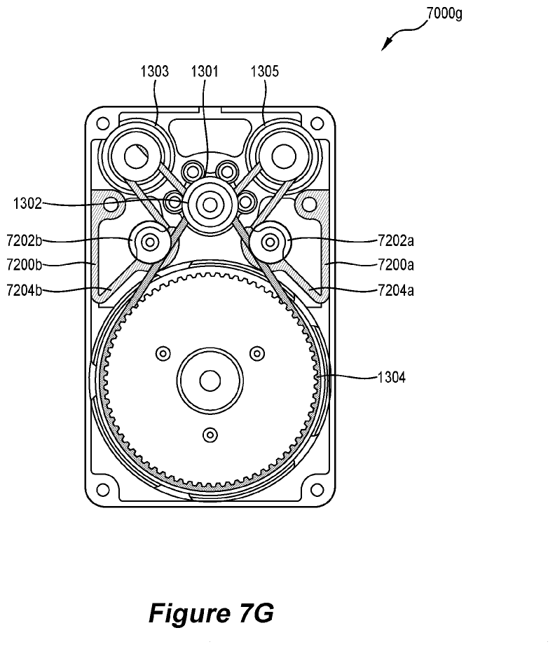

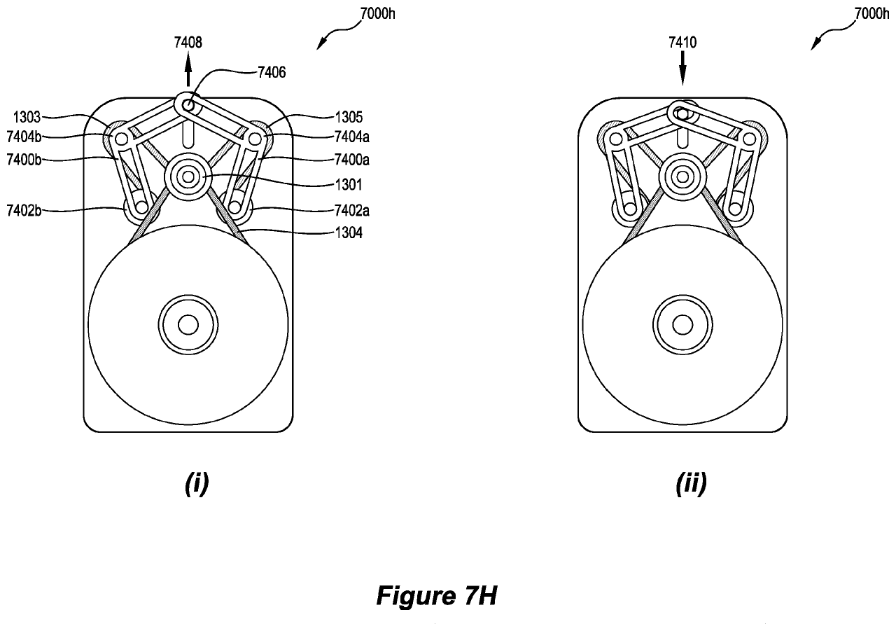

As an example illustrated in FIG. 7, the first dispersive component 606 steers the light beams 607 over the first dimension (e.g. along the x axis depicted in FIG. 7, with or without some deviation over the y axis and/or z axis) based on wavelength. The first dispersive component 606 includes a combination of one or more prisms and one or more diffractive gratings.

The example shown in FIG. 7 includes two prisms 606A and 606C and one diffractive grating 606B in between the prism pair. With this arrangement the outgoing light beams 607 from the first dispersive component 606 may be substantially coaxial (possibly with a lateral displacement) with input light beams 305. Also, the optical components of the beam director 103a may be substantially in line or coaxial. For example the optical component 302, the collimating element 304 (if any) and the first and second dispersive components 606, 608 may be substantially in line or coaxial. This may facilitate a beam director with a relatively compact overall size in comparison to one in which the light path through the beam director includes substantial deviations. In other embodiments with the outgoing light beams 607 may deviate from the direction of propagation of the incoming light 305.

In some embodiments the first dispersive component 606 includes or consists of a grism. As one example, the grism is a silica grism. As another example, the grism is a silicon grism. A silicon grism may provide a higher degree of dispersion than a silica grism. In another embodiment, the dispersive component 606 is a meta-optics element made from a metamaterial. The dispersive component 606 can be designed to be direct vision (for example, by selecting appropriate apex angles of the prisms 606A and 606C), so that light at a designated wavelength (e.g. at or near the centre wavelength) enters and exits the dispersive component 606 at substantially the same angle. That is, at the designated wavelength, the light beam entering the dispersive component 606 is substantially coaxial (with or without a lateral displacement) with the corresponding light beam exiting the dispersive component 606.

The second dispersive component 608 may include one or more prisms. In one example, the second dispersive component 608 includes two wedge prisms 608A and 608B. In one example, the two wedge prisms 608A and 608B may be oriented with their inner surfaces (i.e. surfaces facing each other) and kept parallel to form a Risley prism pair. The Risley prism pair is rotatable along a common rotational axis. For example, the common rotational axis is normal to the inner faces. The two rotatable prisms in the Risley prism pair may provide more degrees of freedom to direct incoming light beam over two dimensions than a single rotatable prism. As illustrated in FIG. 7A(a), a light beam 701 incident on a single rotatable prism 702 can be directed by the prism 702 to trace a circular path 700A by an output light beam 703. If the prism 702 is rotated about the optical axis pf the prism 702 with angle θ1 in the x-y plane, the position (x,y) of the output light beam 703 on an observation screen for the single prism 702 can be defined as:

$$x = {r}_{1} * cos ( {θ}_{1} ) , y = {r}_{1} * sin ( {θ}_{1} ) \qquad ( 1 )$$

wherein r₁ denotes the radius of the circle that the output beam 703 traces out.

As illustrated in FIG. 7A(b), the light beam 701 incident on a Risley prism pair having two rotatable prisms 704 and 706 can be directed by the prism pair to trace another circular path 700B by an output light beam 705. The position (x,y) of the output light beam 705 from two rotatable prisms 704 and 706 in a Risley prism pair on an observation screen for the prism pair can be defined as

$$x = {r}_{1} * cos ( {θ}_{1} ) + {r}_{2} * cos ( {θ}_{2} ) , y = {r}_{1} * sin ( {θ}_{1} ) + {r}_{2} * sin ( {θ}_{2} ) \qquad ( 2 )$$

wherein r₁ denotes the radius of the circle that the output beam 705 traces out by rotating the first prism 704 with an angle θ₁ in the absence of the second prism 706 and r₂ denotes the radius of the circle that the output beam 705 traces out by rotating the second prism 706 with an angle θ₂ in the absence of the first prism 704.

In one example, the prisms 608A and 608B are rotated at the same rate but in counter directions. For example, the prism 608A is rotated by an angle of θ (i.e. θ₁=θ) and the prism 608B is rotated by an angle of −θ (i.e. θ₂=−θ) at any one time. According to the equation (2) as above, the position (x,y) of the output light beam from two rotatable prisms 608A and 608B in the Risley prism pair on an observation screen for the prism pair is calculated as:

$$x = ( {r}_{1} + {r}_{2} ) * cos ( θ ) , y = 0 \qquad ( 3 )$$

Therefore, where the Risley prism pair is configured to rotate at the same rate but in counter directions, a light beam is directed over one dimension (e.g. x dimension) without traversing the orthogonal dimension (e.g. y dimension). As can be seen from equation (3), the amount of beam displacement is based on the rotation angle θ, and is proportional to cos(θ).

In another example, the prisms 608A and 608B are generally rotated relative to each other. For example, the prism 608A is fixed while the prism 608B is rotated. As another example, the prisms 608A and 608B are rotated in the same direction but at different rates. As yet another example, the prisms 608A and 608B are rotated in counter directions and at different rates.

The second dispersive component 608 may be rotated at either a constant or a variable rate within the rotation cycle. The rotation of each of the prisms 608A and 608B may be in one direction, for example clockwise and anti-clockwise respectively, or may change direction, for example clockwise and anti-clockwise respectively for one rotation cycle and anti-clockwise and clockwise respectively for the next. The second dispersive component 608 may be rotated at either a constant or a variable rate over several rotation cycles. The second dispersive component 608 including the prisms 608A and 608B may momentarily stop rotation. That is, the rotation of the second dispersive component 608 may be paused at one time and resumed at a later time. For example, the rotation of one or both of the prisms 608A and 608B may be paused simultaneously and resumed simultaneously at a later time. As an example illustrated in FIG. 7, the second dispersive component 608 steers the light beams 609 over the second dimension along y direction based on rotation.

In the case of variable rate rotation, the second dispersive component 608 may be controlled to rotate faster towards the angle(s) that result in the light beam being steered to one or more maximum displacements (i.e. extreme positions) along a beam steering axis described by Eq. (3), and/or slower away from such angle(s). According to Eq. (3), as the rotating second dispersive component 608 approaches θ equal to 0 or 180 degrees, the beam steering displacement approaches the extreme positions of xₘₐₓ=±(r₁+r₂). Such positions represent physical turning points of the steered beam, where the light beam is steered to the edges of the field of view. If the second dispersive component 608 was to be rotated at a constant rate, the rate of change of displacement x would be expected to slow down towards such positions. By rotating faster at or near such positions (and/or rotating slower away from such positions), the beam spends less time at or near the maximum displacements and more time away from the maximum displacements. Doing so decreases the number of points acquired at or near the edges of the field of view, and/or increases the number of points acquired at or near the centre of the field of view.

In an embodiment, the rate of rotation of the second dispersive component 608 is based on the rotation angle (θ) or beam displacement (x). For example, the rate of rotation is controlled to be higher towards the maximum displacements (e.g. the highest rate of rotation at maximum displacements) and lower towards zero displacement (e.g. the lowest rate of rotation at minimum displacements). In this example, and assuming that beam displacement follows Eq. (3), the maximum rate of rotation is controlled to occur at θ equal to 0 and 180 degrees, that is, at the edges of the field of view. In effect, the graph of displacement over time displays sharper and/or narrower peaks and troughs than does a sinusoidal function, such as approaching a triangular wave.

The rate of rotation may be based on a mathematical function of rotation angle (θ) or beam displacement (x). In one embodiment, the rate of rotation based on the rotation angle that follows a raised powered sinusoidal function, such as A[sin(θ)]⁴+B, where the minimum rate of rotation is equal to B and the maximum rate of rotation is equal to A+B. The maximum rate of rotation may be more than 1.5, 2, 3, 4, or 5 times the minimum rate of rotation. In one example, the maximum and minimum rate of rotation is approximately 2 Hz and 1 Hz, respectively. In another example, the maximum and minimum rate of rotation is approximately 6 Hz and 4 Hz, respectively. In yet another example, the maximum and minimum rate of rotation is approximately 7.5 Hz and 2.5 Hz, respectively. In still yet another example, the maximum and minimum rate of rotation is approximately 8 Hz and 2 Hz, respectively. In a further embodiment, the maximum and minimum rate of rotation is approximately 15 Hz and 2 Hz. In a still further embodiment, the maximum and minimum rate of rotation is approximately 20 Hz and 1 Hz. In any of these embodiments, the rotation may attain a maximum of angular acceleration and/or deceleration of at least 50 Hz/s, 100 Hz/s, 150 Hz/s, 200 Hz/s, 250 Hz/s or 300 Hz/s.

In one embodiment, the rotation of the prisms 608A and 608B is controlled by two electric motors, which are mechanically or electromechanically connected to a housing of the prisms 608A and 608B. In one example, each of the prisms 608A and 608B is placed in a respective hollow-core motor. The rotational axis of each hollow-core motor may be substantially aligned with the common rotation axis of the prisms 608A and 608B. Such substantial alignment may support a synergy in combining the prisms 608A and 608B with the hollow-core motors in a compact footprint. The electric motors may be synchronised to drive the prisms 608A and 608B at the same rate but in counter directions as required.

FIG. 7B shows a schematic representation of a drive system 7000 for effecting rotation of the prisms 608A and 608B. The drive system 7000 may use a single drive source, which may be a single electric motor. An input pulley 1301 is mechanically or electromechanically connected to an electric motor or other drive source (not shown). The input pulley 1301 may for example be a shaft of a motor, or may be mechanically connected to a shaft of a motor.

The input pulley 1301 is configured to drive a first free-spinning pulley 1303 and a second free-spinning pulley 1305 through a double-sided contact belt 1302, which in turn drives a first output pulley 1307. In particular, one side of the double-sided contact belt 1302 contacts the input pulley 1301 while the other side of the double sided contact belt 1302 contacts the first output pulley 1307 through the free-spinning pulleys 1303 and 1305. In this configuration, both free-spinning pulleys 1303 and 1305 and the first output pulley 1307 rotate with the input pulley 1301 but in a counter direction, i.e. each counter-rotates relative to the input pulley 1301.

The input pulley 1301 is also configured to drive a second output pulley 1309 through a single-sided contact belt 1304. One side of the single-sided contact belt 1304 contacts both the input pulley 1301 and the second output pulley 1309. In this configuration, the second output pulley 1309 rotates with the input pulley 1301 in the same direction, i.e. co-rotates with the input pulley 1301. The first output pulley 1307 and the second output pulley 1309 are configured in a co-axial arrangement to rotate about a common rotational axis C. The first and second output pulleys 1307 and 1309 are each configured to mount one of the prisms 608A and 608B in a hollow centre 1300. For example, the first output pulley 1307 mounts the prism 608A and the second output pulley 1309 mounts the prism 608B so as to synchronously rotate the prisms 608A, 608B in opposite directions responsive to rotational drive of the input pulley 1301.

FIG. 7C schematically illustrates a perspective view of the drive system of FIG. 7B. Each of the input pulley 1301 and the free-spinning pulleys 1303 and 1305 may be configured to extend along the axis C. The input pulley 1301 may extend at least over the distance between the first and second co-axial output pulleys 1307 and 1309 (D) so as to allow the contact belts 1302 and 1304 to be parallel to each other. As the two output pulleys 1307 and 1309 are alike, having the same diameter, they rotate synchronously in counter directions. It will be appreciated that the diameters of each of the two free-spinning pulleys 1303 and 1305 and the input pulley 1301 do not have to be the same in order for the output pulleys to rotate synchronously.

In other embodiments, the pulleys and belts of the pulley-belt based drive system shown in FIGS. 7B and 7C may be replaced by gears and chains, respectively, to form a gear-chain based drive system to provide the mechanical synchronisation function. In particular, the input pulley, free-spinning pulleys and output pulleys are replaced with an input gear, two free-spinning gears, and output gears, respectively. The double-sided contact belt and the single-sided contact belt are replaced with chains.

In some embodiments, the input pulley 1301 (or gear) is instead a free-spinning pulley and either of the free-spinning pulleys 1303 or 1305 is connected to the drive source to be the input pulley. In other embodiments the drive source drives one of the output pulleys 1307 or 1309 (or gears). In some embodiments there is more than one drive source, in which case the drive system may serve to synchronise the two or more drive sources.

In yet another embodiment of a drive system 7000a as shown in FIGS. 7D, first and a second free-spinning gears 1303a and 1305a may be in contact with or directly coupled with an input gear 1301a. The input gear 1301a is mechanically or electromechanically connected to an electric motor (not shown). The free-spinning gears 1303a and 1305a are rotated with the input gear 1301a but in a counter rotation. In other embodiments the input or driven gear may instead be the gear 1303a or the gear 1305a.

A first output gear 1307a is connected with the two free-spinning gears 1303a and 1305a through a first chain 1302a. The first output gear 1307a is therefore configured to rotate with the two free-spinning gears 1303a and 1305a, which in turn rotate with the input gear 1301a, but in a counter direction to the input gear 1301a. The input gear 1301a is also configured to drive a second output gear 1309a through a second chain 1304a. The second output gear 1309a rotates with the input gear 1301a in the same direction, i.e. co-rotates with the input gear 1301a. It will be appreciated that the chains and gears may be replaced by belts and pulleys, provided the drive pulley couples with the free-spinning pulleys, for example by friction (which may be increased by surface treatment or by placing a coating or covering over the pulleys or by teeth provided on the pulleys.

In some embodiments the drive system 7000a is configured so that the coupling of the free-spinning gears 1303a and 1305a to the input gear 1301a is separated from the chains. For example, the second chain 1304a may be located forward of the two free-spinning gears 1303a and 1305a or in other words the two free-spinning gears 1303a and 1305a terminate in the Z direction before reaching the location on the input gear 1301a that contacts the second chain 1304a. In other embodiments the input gear 1301a may include a recess so that the chain 1304a is accommodated within the outer periphery of the input gear 1301a, so as to not contact the two free-spinning gears 1303a and 1305a. Like recesses may be provided in the free-spinning gears 1303a and 1305a to retain the synchronicity of the drive system 7000a.

Like the embodiment described with reference to FIGS. 7B and 7C, the first output gear 1307a and the second output gear 1309a are configured in a co-axial arrangement and rotate about a common rotational axis C. The first and second output gears 1307a and 1309a are configured to each mount one of the prisms 608A and 608B. For example, the first and second output pulleys 1307a and 1309a have a hollow centre 1300a configured to receive and retain one of the prisms 608A and 608B. This “in-contact” configuration of the input and two free-spinning gears may result in a further reduced footprint of the beam director and the system that the beam director is placed in. It will be appreciated that the diameters of the two free-spinning gears 1303a and 1305a and the input gear 1301a do not have to be the same as each other.

In another embodiment, one of the single free-spinning gears 1303a or 1305a are omitted, with the first chain 1302a extending around the remaining free-spinning gear only. The remaining free-spinning gear remains directly coupled to the input gear 1301a. For example, as illustrated in FIG. 7E, the two free-spinning gears may be replaced with a single free-spinning gear 1311. In FIG. 7E components of the drive system 7000b similar to the drive system 7000a described with reference to FIG. 7D are shown with like reference numerals.

The diameter of the free-spinning gear 1311 may be different from the input gear 1301a. Alternatively, the diameter of the free-spinning gear 1311 may be the same as the input gear 1301a (i.e. d1=d2), with the gears 1311 and 1301a offset from each other to provide space for placing the chains 1302a and 1304a, respectively.

In the drive system 7000b, the free-spinning gear 1311 is in contact with or directly coupled with the input gear 1301a and therefore rotates with the input gear 1301a but in a counter direction. The first output gear 1307a is connected with the free-spinning gear 1311 through the first chain 1302a. The first output gear 1307a is therefore configured to rotate with the free-spinning gear 1311 and in turn rotated with the input gear 1301a but in a counter direction.

The input gear 1301a is also configured to drive the second output gear 1309a through the second chain 1304a as discussed above. In this regard, the second output gear 1309a rotates with the input gear 1301a in the same direction, i.e. co-rotates with the input gear 1301a. As discussed above, the first and second output gears 1307a and 1309a are configured to mount one of the prisms 608A and 608B, respectively. As the two output gears 1307a and 1309a are alike, having the same diameter, they rotate synchronously in counter directions.

It will be appreciated that the location of the coupling of the free-spinning gears 1303a and/or 1305a may be varied without affecting the operation of the drive system. For example the gears may be aligned along the y axis, along the x axis or the free-spinning gear or gears may be located below the input gear.

FIG. 7F illustrates an embodiment of a drive system 7000c that is similar to the drive system 7000 as illustrated in FIGS. 7B and 7C, but includes a double-sided 1302b configured in a different way to the double-sided contact belt 1302 as in FIGS. 7B and 7C. In FIG. 7F like components and features of the drive system 7000c to the drive system 7000 described with reference to FIGS. 7B and 7C are shown with like reference numerals.

In FIGS. 7B and 7C, the double-sided contact belt 1302 engages alternately-rotating pulleys in sequence before engaging the first output pulley 1307. For example, the double-sided contact belt 1302 engages the corresponding pulleys in this sequence: clockwise-rotating the pulley 1303, anti-clockwise-rotating the pulley 1301, clockwise-rotating the pulley 1305. In FIG. 7F, the double-sided 1302b engages the co-rotating pulleys at least once before engaging the first output pulley 1307. For example, the double-sided contact belt 1302B engages the corresponding pulleys in this sequence: clockwise-rotating the pulley 1303, clockwise-rotating the pulley 1305, anti-clockwise-rotating the pulley 1301. The single-sided contact belt 1304 engages the input pulley 1301 and the second output pulley 1309 in the same way as in FIGS. 7B and 7C.

In some embodiments, the drive system may include one or more belt tensioning systems 7200. Each of the one or more belt tensioning systems 7200 may avoid or reduce belt tensioning issues, such as loosening or tightening over time, over operating temperature, or during variable-speed operation.

In the embodiment of FIG. 7G, a drive system 7000g includes two belt tensioning systems 7200a and 7200b. In FIG. 7G like components and features of the drive system 7000g to the drive system 7000 described with reference to FIGS. 7B and 7C are shown with like reference numerals.

Each of the one or more belt tensioning systems (i.e. 7200a and 7200b as illustrated in FIG. 7G) includes a contact pulley 7202 (i.e. 7202a for the belt tensioning system 7200a, 7202b for the belt tensioning system 7200b) for engaging the corresponding belt (i.e. the belt 1302 in FIG. 7G). In one example, the contact pulley 7202a engages the belt 1302 at a position between the free-spinning pulley 1305 and the output pulley 1307 and the contact pulley 7202b engages the belt 1302 at a position between the free-spinning pulley 1303 and the output pulley 1309 as illustrated in FIG. 7G. In other example, the contact pulley 7202 of each of the belt tensioning systems 7200 may engage with the corresponding belt at other positions. Each of the one or more belt tensioning systems 7200a and 7200b also includes a flexible component (7204a, 7204b) for belt tension correction. The flexible component (7204a, 7204b) may include a cantilever which opens and closes depending on the pressure exerted on the corresponding contact pulley (7202a, 7202b).

Where the belt is sufficiently loose (i.e. the pressure exerted on the contact pulley 7202 is sufficiently low), the contact pulley 7202 is biased towards the belt to close the cantilever for maintaining belt tension. Where the belt is sufficiently tightened, the contact pulley 7202 is biased away from the belt to open the cantilever for maintaining belt tension.

In some embodiments, the one or more belt tensioning systems may be mechanically linked. Mechanically linking the belt tensioning systems may better equalise tension provided by the different belt tensioning systems.

In one example, FIG. 7H illustrates a drive system 7000h including two belt tensioning systems 7400a and 7400b which are mechanically linked through a camshaft 7406. In FIG. 7H like components and features of the drive system 7000h to the drive system 7000 described with reference to FIGS. 7B and 7C are shown with like reference numerals. In particular, the belt tensioning systems (e.g. 7400a and 7400b) each include (a) a contact pulley (e.g. 7402a, 7402b) for engaging the belt (e.g. 1302) and (b) a flexible component (e.g. 7404a, 7404b) for tension correction. The flexible components (e.g. 7404a and 7404b) each include an arm engaged with the camshaft 7406. The camshaft 7406 is configured to translate resiliently, for example, by coupling to a spring (not shown) that urges the camshaft 7406 to move in a linear path.

When the belt 1302 is sufficiently loose, the contact pulley 7402a (and/or the contact pulley 7402b) is biased towards the belt 1302 to move the spring-loaded camshaft 7406 towards one direction 7408 as shown in FIG. 7H(i). Where the belt is sufficiently tightened, the contact pulley 7402a (and/or the contact pulley 7402b) is biased away the belt 1302 to move the spring-loaded camshaft 7406 towards the opposite direction 7410 as shown in FIG. 7H(ii).

Using a mechanical synchronisation system, for example as described with reference to the FIGS. 7B to 7H, may simplify and/or improve synchronisation of the prisms 608A, 608B. For instance, it may be relatively more difficult or complex to synchronise two motors to rotate with an equal but opposite rotation rate, especially if the rotation rate is controlled to be variable, whether within a rotation cycle or over several rotation cycles.

Alternatively, in some embodiments the diameters of the sections of the output pulley or gears that receive the belt or chain may be different. These embodiments may be utilised to achieve a fixed differential rotational rate between the output pulley/gears.

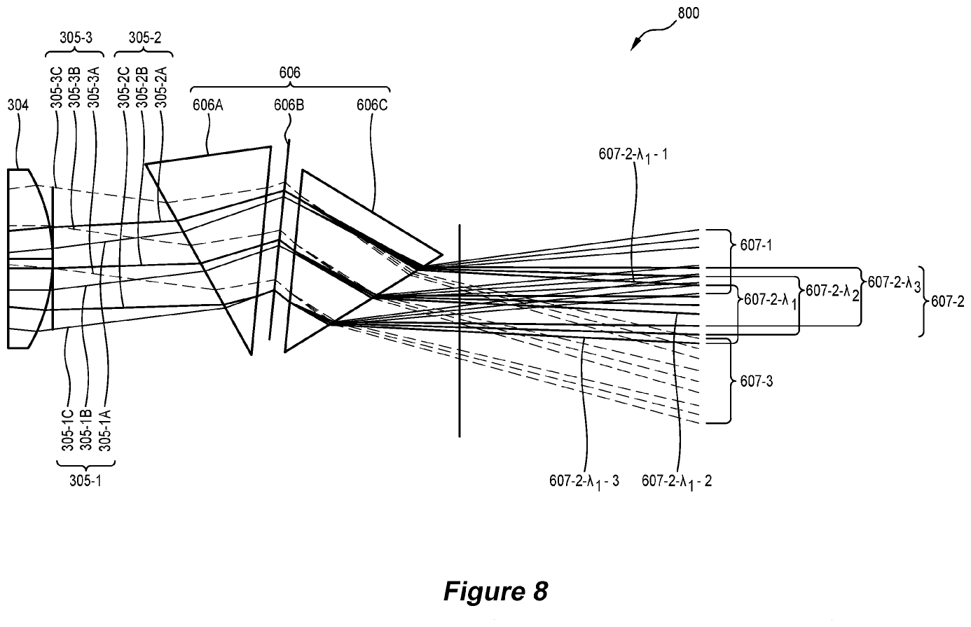

FIG. 8 illustrates an exemplary simulated ray tracing 800 of light at the x-y plane defined in FIGS. 6-7 through example components from FIG. 6 and FIG. 7. The ray tracing 800 shows an example in which the light entering the collimating element 304 and the first dispersive component 606 (including the first prism 606A, the grating 606B and the second prism 606C) is from an optical component 302 with three output ports (M=3) each providing light beam at wavelength λ₁, λ₂ and λ₃ (N=3).

After the collimating element 304, three traces are shown for each beam (305-1, 305-2 and 305-3) from the output ports 302O-1, 302O-2 and 302O-3, to represent the size of the corresponding beam as it traverses the beam director. The middle trace (305-1B, 305-2B or 305-3B) of each beam (305-1, 305-2 or 305-3) represents the beam centre and the two outer traces (305-1A and 305-1C, 305-2A and 305-2C, or 305-3A and 305-3C) represent the radial extent where the beam intensity drops to 1% of the intensity at the beam centre.

The collimated light beams 305-1, 305-2 and 305-3 enter the first dispersive component 606, which outputs the light beams 607-1, 607-2 and 607-3. As illustrated in FIG. 8, each light beam 607-1, 607-2 or 607-3 has three groups of light beams. Each group of light beams in the light beam 607-1, 607-2 or 607-3 represents a light beam at a different wavelength (i.e. λ₁, λ₂ and λ₃). For example, the light beam 607-2 has three groups of light beams 607-2-λ₁, 607-2-λ₂, and 607-2-λ₃ which overlap substantially with each other. As noted, only three traces are shown in each of the light beams 607-2-λ₁, 607-2-λ₂, and 607-2-λ₃ to represent the size of the corresponding beam. That is, the middle trace (e.g. 607-2-λ₁-2) of each beam (e.g. 607-2-λ₁) represents the beam centre and the two outermost traces (e.g. 607-2-λ₁-1 and 607-2-λ₁-3) represent the radial extent where the beam intensity drops to 1% of the intensity at the beam centre. In the simulation, λ₁, λ₂ and λ₃ are set as 1529 nm, 1550 nm and 1569 nm, respectively. As a result, the first dispersive component 606 steers light beams 607 in the x direction based on the wavelength.

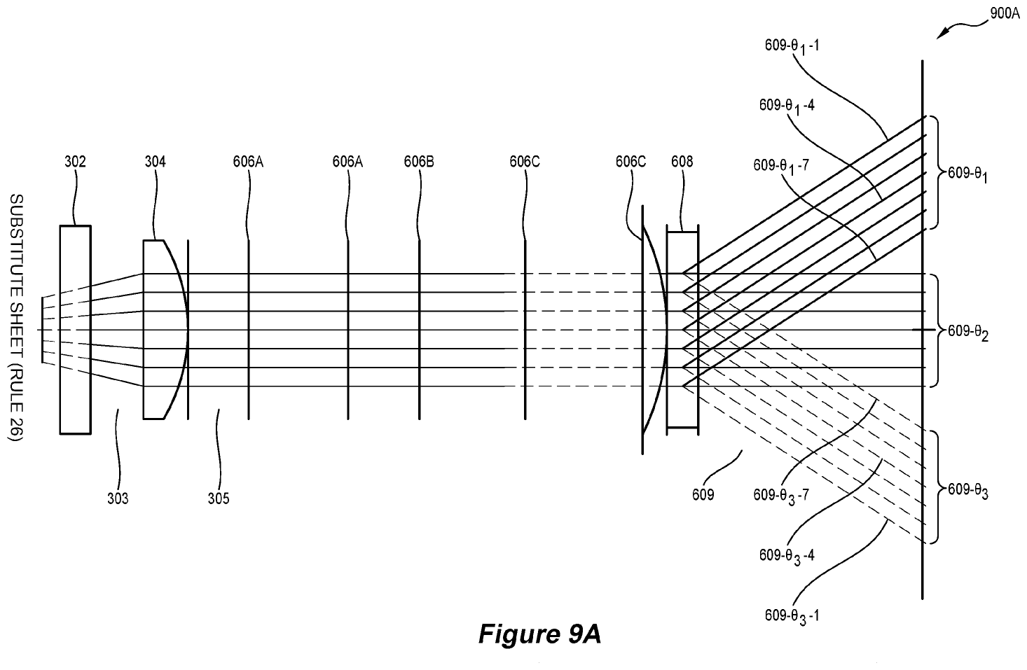

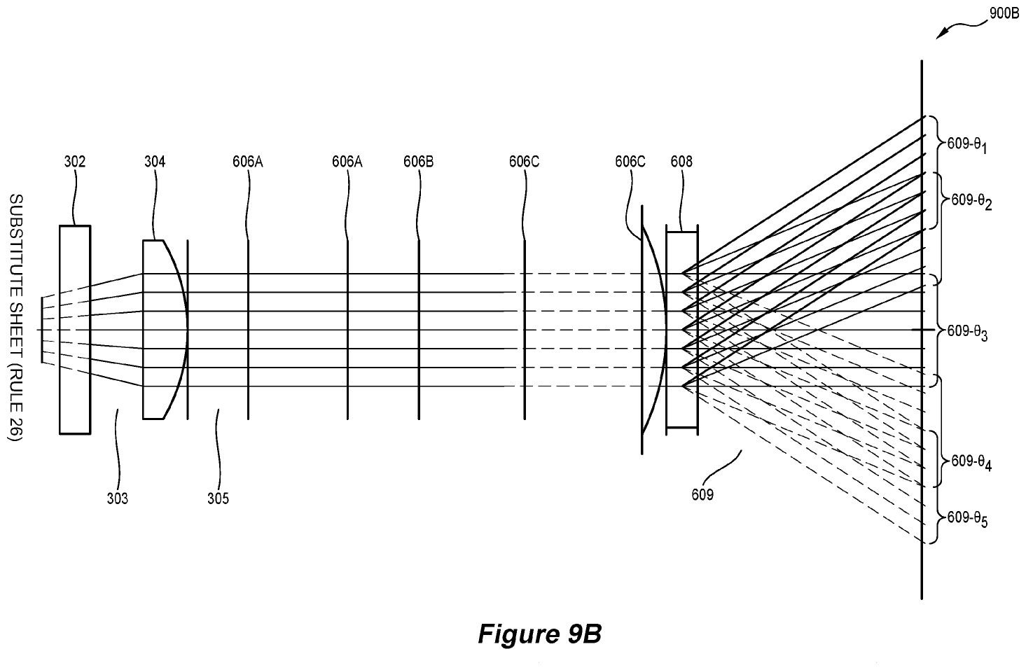

FIG. 9A illustrates an exemplary simulated ray tracing 900A at the y-z plane defined in FIGS. 6-7 showing light through the collimating element 304, the first dispersive component 606 including the first prism 606A, the grating 606B and the second prism 606C and the second dispersive component 608 including a Risley prism pair rotated at the same rate but in counter direction, again from three output ports (M=3) each providing light beam at wavelength λ₁, λ₂ and λ₃ (N=3). The beams 609-θ₁, 609-θ₂ and 609-θ₃ represent the beams as a result of the rotation of the second dispersive component 608 at angles θ₁, θ₂ and θ₃, respectively. Seven traces of each beam (609-θ₁, 609-θ₂ or 609-θ) are shown to represent the size of the corresponding beam. That is, the middle trace (e.g. 609-θ₁-4, 609-θ₃-4) of each beam (609-θ₁, 609-θ₂ or 609-θ₃) represents the beam centre and the two outermost traces (609-θ₁-1 and 609-θ₁-7, 609-θ₃-1 and 609-θ₃-7) represent the radial extent where the beam intensity drops to 1% of the intensity at the beam centre. As a result, the rotated second dispersive component 608 steers light beams 609 in the y direction based on rotation.

FIG. 9B illustrates another exemplary simulated ray tracing 900B similar to the ray tracing 900A, but with five different rotation angles (i.e. θ₁, θ₂, θ₃, θ₄ and θ₅) resulting in light beams (609-θ₁, 609-θ₂, 609-θ₃, 609-θ₄ and 609-θ₅).

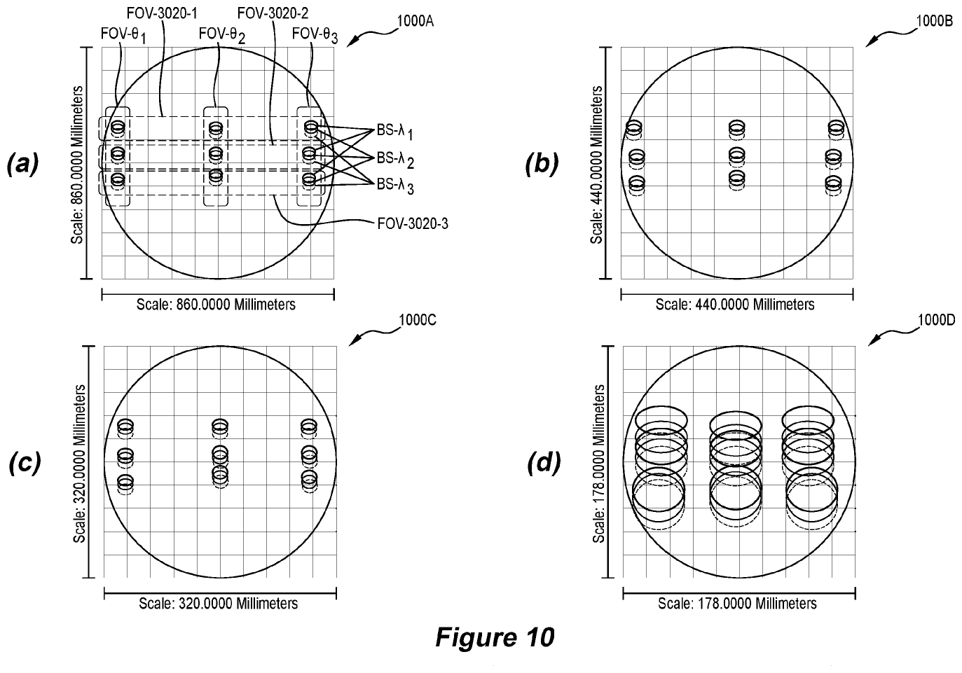

FIGS. 10(a)-(d) illustrate exemplary overall FOVs 1000A, 1000B, 1000C and 1000D at the x-y plane (see FIG. 6 and FIG. 7) at a decreasing distance from the beam director 103 (i.e. 1000A corresponds to the x-y plane furthest from the beam director 103 and 1000D corresponds to the x-y plane closest to the beam director 103) resulting from rotating the second dispersive component 608 and from varying the wavelength of the outgoing light beams. The light is provided by an optical component 302 with three output ports (302O-1, 302O-2 and 302O-3) at wavelengths λ₁, λ₂ and λ₃. In the simulation, λ₁, λ₂ and λ₃ are set as 1529 nm, 1550 nm and 1569 nm, respectively. As illustrated, the overall FOV (1000A, 1000B, 1000C or 1000D) is substantially rectangular. Field of views FOV-302O-1, FOV-302O-2 and FOV-302O-3 are provided by the output ports 302O-1, 302O-2 and 302O-3, respectively. Field of views FOV-θ₁, FOV-θ₂ and FOV-θ₃ are provided by rotating the second dispersive component 608 at angles θ₁, θ₂ and θ₃, respectively. Each circular or elliptical spot in the overall FOVs 1000A, 1000B, 1000C and 1000D represent a beam size of a light beam at a corresponding wavelength. The boundary of the beam size is set as where the light intensity drops to 1% of the light intensity at the beam centre. For example, BS-λ₁, BS-λ₂ and BS-λ₃ are provided by the light beams at wavelengths λ₁, λ₂ and λ₃, respectively. As noted, the actual beam size does not substantially vary from FIG. 10(a) to FIG. 10(d).

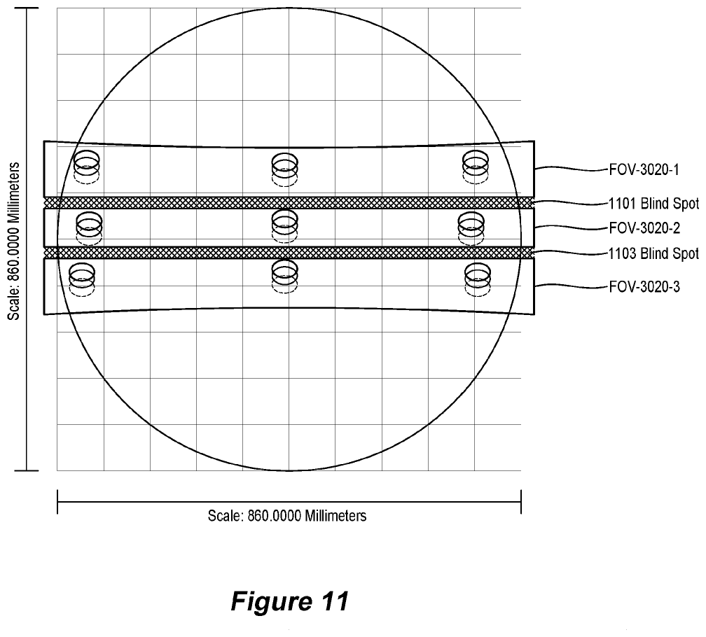

FIG. 10(a) is reproduced in FIG. 11 to illustrate blind spots 1101 and 1103 between the FOVs from neighbouring output ports, which are deliberately made large in the simulation for illustrative purposes. As discussed above, the blind spots may be avoided or reduced by adjusting the separation distance between neighbouring output ports 302O-1, 302O-2, . . . , 302O-M.

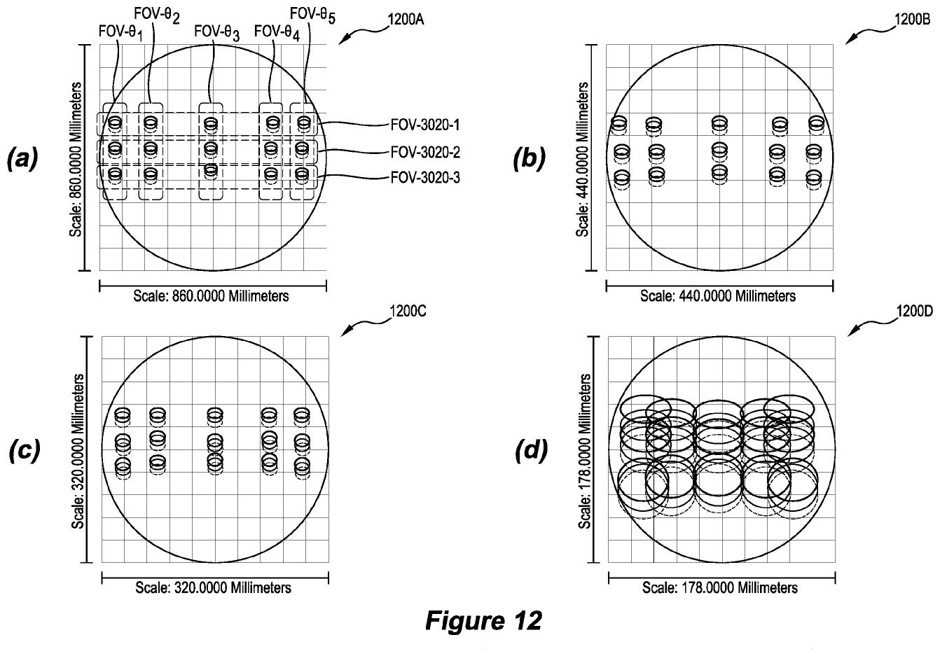

FIGS. 12(a)-(d) illustrate another set of exemplary overall FOVs 1200A, 1200B, 1200C and 1200D at the x-y plane at decreasing distanced from the beam director 103, resulting from rotating the second dispersive component 608 at five different angles (θ₁, θ₂, θ₃, θ₄ and θ₅) and from varying the wavelength of the outgoing light beams. Again the light is provided from an optical component 302 with three output ports (302O-1, 302O-2 and 302O-3) each providing the outgoing light beams at wavelengths λ₁ (1529 nm), λ₂ (1550 nm) and λ₃ (1569 nm) in the beam director 103.

In the embodiment of the beam director 103a as illustrated in FIGS. 6 and 7, the output ports 302O-1, 302O-2, . . . , 302O-M are arranged spatially offset along the wavelength dimension (i.e. a “fast axis”, the x axis depicted in FIGS. 6 and 7). In this embodiment, light from each of the output ports 302O-1, 302O-2, . . . , 302O-M is directed across the same FOV along the mechanical dimension (i.e. a “slow axis”, the y axis depicted in FIGS. 6 and 7), for example, as illustrated in FIG. 12(a).

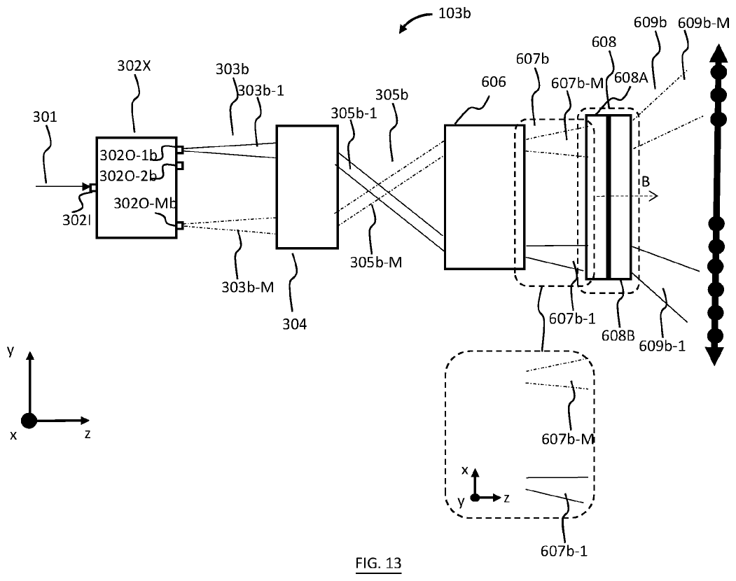

FIG. 13 illustrates another embodiment of a beam director 103b viewed from the y-z plane of FIG. 6. In FIG. 13 like components and features of the beam director 103b to the beam director 103a described with reference to FIGS. 6 and 7 are shown with like reference numerals.

The beam director 103b is different from the beam director 103a in that the output ports 302O-1b, 302O-2b, . . . , 302O-Mb are arranged spatially offset along the mechanical dimension (i.e. the y axis depicted in FIG. 13). In this regard, light from each of the output ports 302O-1b, 302O-2b, . . . , 302O-Mb is directed across different FOVs along the mechanical axis. The spatially offset output ports 302O-1b, 302O-2b, . . . , 302O-Mb causes corresponding collimated light beams 305-1b, . . . , 305-Mb to be angularly offset. In some embodiments the angular offset causes the collimated light beams 305-1b, . . . , 305-Mb to be directed to different and overlapped FOVs along the mechanical dimension (i.e. the y axis depicted in FIG. 13). Configuring the beam director 103b to have overlapped FOVs along the mechanical dimension, provided by the light from each of the output ports 302O-1b, . . . , 302O-Mb that are arranged spatially offset along the mechanical dimension, provides greater point density in the overlapping area of the overall FOV at the x-y plane relative to the point density at the edges of overall FOV.

Specifically, the beam director 103b receives outgoing light 301, from the light source 120 including wavelength channels λ₁, λ₂, . . . λ_{N}. The beam director 103b includes an optical component 302X having an optical input port 302I and at least two optical output port (302O-1b, 302O-2b, . . . , 3020-Mb, M≥2). Each output port may provide outgoing light at one wavelength channel only or may provide outgoing light at more than one wavelength channel, for example one wavelength channel at one time period and another wavelength channel at another time period or more than one wavelength channel at a time. Example embodiments of the optical component 302X of FIG. 13 are described herein with reference to FIG. 3B. In another embodiment (not shown), the beam director includes at least two fibre (302B-1b, 302B-2b, . . . , 302B-Mb, M≥2) without an optical beam splitter 302A or optical switch 302C as illustrated in FIG. 3B, one end of each fibre (302I-1b, 302I-2b, . . . , 302I-Mb, M≥2) being connected to a respective laser in the light source 102. The light source 102 may select one wavelength channel at a time for each laser or may simultaneously activate two or more lasers each providing a selected wavelength channels. The selected wavelength channels for each laser in the light source 102 may be the same of different. The other end of each fibre serves as an output port (302O-1b, 302O-2b, . . . , 302O-Mb, M≥1) and outputs expanding light beams 303b-1, 303b-2, . . . , 303b-M (collectively 303b), respectively. As mentioned above, the output ports 302O-1b, 302O-2b, . . . , 302O-Mb are arranged spatially offset along the mechanical dimension (i.e. the y axis depicted in FIG. 13).

The expanding light 303b having multiple beams (303-1b, . . . , 303-Mb), each from one of the output ports 302O-1, 302O-2, . . . , 302O-M, is received by the at least one collimating element 304 for producing corresponding collimated light 305b having multiple beams (305b-1, . . . , 305b-M) each corresponding to one of the expanding beams 303b-, . . . , 303b-M. The collimated light 305b is received by the first dispersive component 606 for steering the collimated light 305b in multiple directions based on wavelength over a first dimension (i.e. “the wavelength dimension” or “dispersion dimension”, the x axis as depicted in FIG. 13 and its inset). The first dispersive component 606 is followed by the second dispersive component 608. The second dispersive component 608 is rotated, for steering the outgoing light over a second dimension (i.e. “the mechanical dimension”) throughout a rotation cycle. For example, the second dispersive component 608 may be rotated about the axis B.

As noted, the figures are shown for illustrative purposes only and may not be in scale. For example, the output ports 302O-1b, . . . , 302O-Mb may be positioned close to each other such that the beams 305b-1, . . . , 305b-M to some extent or largely overlap with each other and/or that beams 607b-1, . . . , 607b-M (collectively 607b) to some extent or largely overlap with each other. The separation distance between neighbouring output ports 302O-1b, 302O-2b, . . . , 302O-Mb may be adjusted such that the adjacent outgoing light beams 609b-1, 609b-2, . . . , 609b-M (collectively 609b) overlap, for avoiding blind spots.

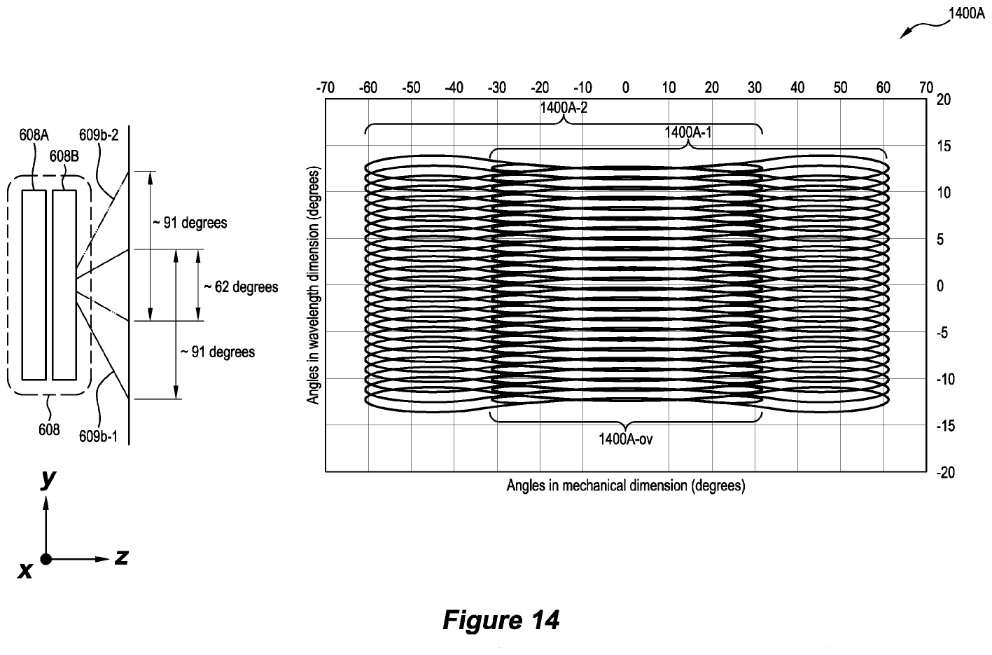

FIG. 14 illustrates an exemplary overall FOV 1400A at the x-y plane. The output light is provided from an embodiment of the beam director 103b with its optical component 302X having two output ports (302O-1b and 302O-2b), each providing the outgoing light beams in the beam director 103b. The output ports 302O-1b and 302O-2b are arranged spatially offset along the mechanical dimension, which causes the corresponding beams before the dispersive component 608 (i.e. 607b-1 and 607b-2) to be angularly offset from around 8.916 degrees to around −8.916 degrees relative to the propagation direction (i.e. the z axis in FIG. 14). The light from each of the output ports 302O-1b and 302O-2b is directed across different and overlapped FOVs. The light from each of the output ports 302O-1b and 302O-2b is directed across different and overlapped FOVs (1400A-1 and 1400A-2, respectively) along the mechanical dimension, each extending around 91 degrees along the mechanical dimension in this example. The overlapped area (around 62 degrees along the mechanical dimension in this example) of the FOVs 1400A-1 and 1400A-2 is illustrated as 1400A-ov in FIG. 14. As illustrated, the overall FOV 1400A is substantially rectangular. The point density in the overlapped area 1400A-ov (i.e. from around −31 to around 31 degrees along the mechanical dimension in this example) is greater than the point density at the non-overlapped area (i.e. between around −60 degrees and around −31 degrees, and between around 31 degrees and around 60 degrees, along the mechanical dimension in this example).

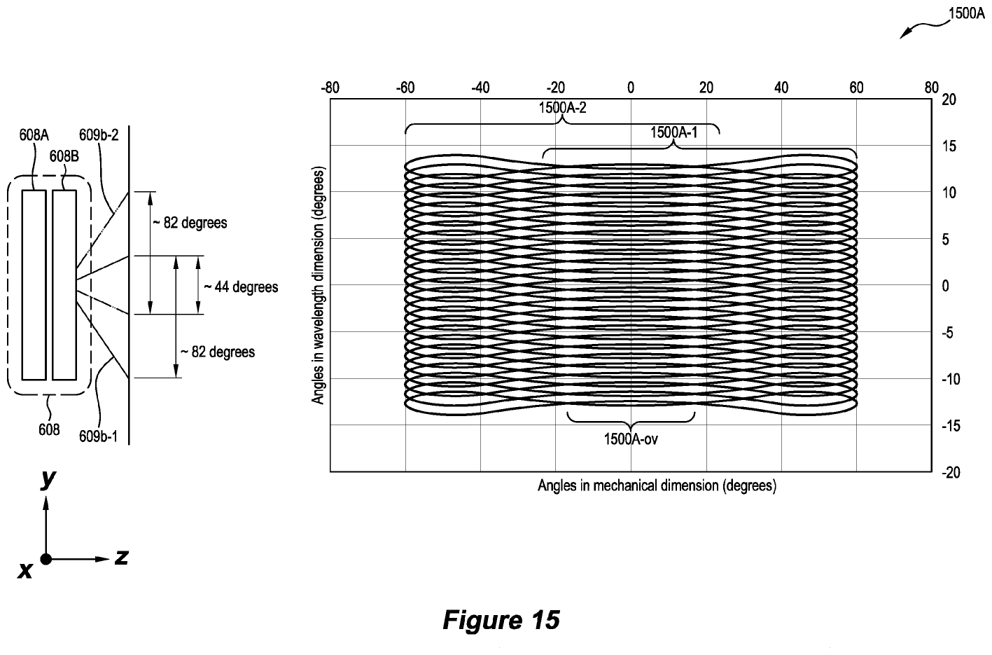

FIG. 15 illustrates another exemplary overall FOV 1500A at the x-y plane. The output light is provided from an embodiment of the beam director 103b with its optical component 302X having two output ports (302O-1b and 302O-2b), each providing the outgoing light beams in the beam director 103b. The output ports 302O-1b and 302O-2b are arranged spatially offset along the mechanical dimension, which causes the corresponding beams before the dispersive component 608 (i.e. 607b-1 and 607b-2) to be angularly offset from around 13.045 degrees to around −13.045 degrees relative to the propagation direction (i.e. the z axis in FIG. 15). The light from each of the output ports 302O-1b and 302O-2b is directed across different and overlapped FOVs. The light from each of the output ports 302O-1b and 302O-2b is directed across different and overlapped FOVs (1500A-1 and 1500A-2, respectively) along the mechanical dimension, each extending around 82 degrees along the mechanical dimension in this example. The overlapped area (around 44 degrees along the mechanical dimension in this example) of the FOVs 1500A-1 and 1500A-2 is illustrated as 1500A-ov in FIG. 15. As illustrated, the overall FOV 1500A is substantially rectangular. The point density in the overlapped area 1500A-ov (i.e. from around −22 to around 22 degrees along the mechanical dimension in this example) is greater than the point density at the non-overlapped area (i.e. between around −60 degrees and around −22 degrees, and between around 22 degrees and around 60 degrees, along the mechanical dimension in this example).

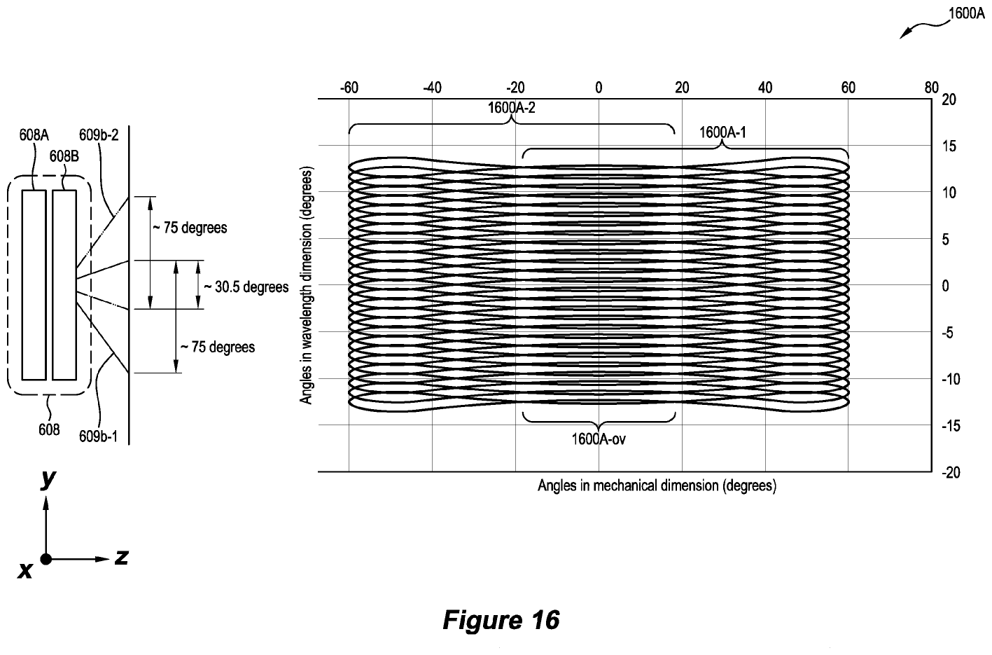

FIG. 16 illustrates another exemplary overall FOV 1600A at the x-y plane. The output light is provided from an embodiment of the beam director 103b with its optical component 302X having two output ports (302O-1b and 302O-2b), each providing the outgoing light beams in the beam director 103b. The output ports 302O-1b and 302O-2b are arranged spatially offset along the mechanical dimension, which causes the corresponding beams before the dispersive component 608 (i.e. 607b-1 and 607b-2) to be angularly offset from around 16.308 degrees to around −16.308 degrees relative to the propagation direction (i.e. the z axis in FIG. 16). The light from each of the output ports 302O-1b and 302O-2b is directed across different and overlapped FOVs. The light from each of the output ports 302O-1b and 302O-2b is directed across different and overlapped FOVs (1600A-1 and 1600A-2, respectively) along the mechanical dimension, each extending around 75 degrees along the mechanical dimension in this example. The overlapped area (around 30.5 degrees along the mechanical dimension in this example) of the FOVs 1600A-1 and 1600A-2 is illustrated as 1600A-ov in FIG. 16. As illustrated, the overall FOV 1600A is substantially rectangular. The point density in the overlapped area 1600A-ov (i.e. from around −15.25 to around 15.25 degrees along the mechanical dimension in this example) is greater than the point density at the non-overlapped area (i.e. between around −60 degrees and around −22 15.25 degrees, and between around 15.25 degrees and around 60 degrees, along the mechanical dimension in this example).

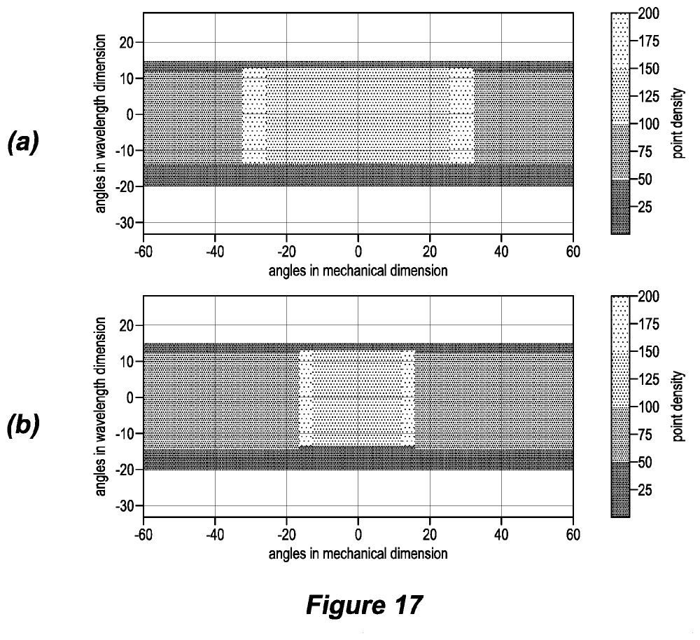

As can be seen from FIGS. 14, 15 and 16, the overall FOVs 1400A, 1500A, and 1600A have substantially the same size. FIG. 17 illustrates an exemplary point density comparison between FOV 1400A and 1600A). In particular, FIG. 17(a) illustrates a point density for the overall FOV 1400A and while 17(b) illustrates a point density for the overall FOV 1600A. In a central area of the respective FOV (i.e. from −5 degrees to 5 degrees in the wavelength dimension and from −15 degrees to 15 degrees in the mechanical dimension in this example of the respective FOV), the FOV 1400A with about 62-degree overlap between individual FOVs 1400A-1 and 1400A-2 has a point density of around 67 points/degrees², which is less than the point density (i.e. about 110 points/degrees²) of the FOV 1600A with a smaller overlap (i.e. about 30.5 degrees) between individual FOVs 1600A-1 and 1600A-2. Also, it will be understood that the overlapped area between the individual FOVs of the corresponding output ports (302O-1b, . . . , 302O-Mb) will result in a reduced overall FOV compared to the embodiment where there is no overlapped area between the individual FOVs of the corresponding output ports (302O-1b, . . . , 302O-Mb).

In yet another embodiment (not shown), a plurality of the output ports 302O-1, 302O-2, . . . , 302O-M are arranged spatially offset along the wavelength dimension and a plurality of the output ports are arranged spatially offset along the mechanical dimension.

It will be understood that the invention disclosed and defined in this specification extends to all alternative combinations of two or more of the individual features mentioned or evident from the text or drawings. All of these different combinations constitute various alternative aspects of the invention.

What is claimed is:

1. An optical beam director including at least one dispersive component configured to receive light and to be rotated about a rotational axis for beam steering in at least one dimension, wherein the at least one dispersive component includes two prisms and the optical beam director is configured to rotate the two prisms in counter directions and is configured to rotate at least one of the prisms at a variable rate.

2. The optical beam director of claim 1, wherein the optical beam director is configured to rotate at least one of the prisms at a variable rate within a rotation cycle.

3. The optical beam director of claim 1, wherein the optical beam director is configured to rotate the at least one of the prisms at a variable rate over a plurality of rotation cycles.

4. The optical beam director of claim 1, wherein the optical beam director is configured to stop rotating the second dispersive component at one time and resume rotating the second dispersive component at a later time.

5. The optical beam director of claim 1, wherein the optical beam director is configured to rotate the at least one of the prisms faster towards angle(s) that result in the incoming light beam being steered to one or more maximum displacements along a beam steering axis, and/or slower away from such angle(s).

6. The optical beam director of claim 1, wherein the two prisms are a Risley prism pair.

7. The optical beam director of claim 1, wherein the two prisms are rotated at substantially the same rate.

8. The optical beam director of claim 7, wherein the two prisms are configured to be rotated in counter directions by a drive system, the drive system including:
a first rotating element;
at least one second rotating element coupled to the first rotating element to rotate with the first rotating element in a counter direction;
a third rotating element configured with a connection to the at least one second rotating element to rotate with the at least one second rotating element in the same direction;
a fourth rotating element configured with a connection to the first rotating element to rotate with the first rotating element in the same direction;
wherein
the third and fourth rotating elements each mount one of the two prisms; and
at least one of the rotating elements is configured to receive and rotate responsive to force from a drive source.

9. The optical beam director of claim 8 wherein the at least one second rotating element comprises two rotating elements, coupled to the first rotating element by a belt or chain, wherein the belt or chain is configured in a double-sided arrangement to effect the rotation in the counter direction.

10. The optical beam director of claim 9 where the belt is used, further comprising one or more belt tensioning systems, wherein the one or more belt tensioning systems comprises: a contact pulley for engaging the belt; and a flexible component for tension correction.

11. The optical beam director of claim 10 wherein the one or more belt tensioning systems are mechanically linked.

12. The optical beam director of claim 8, wherein the third and fourth rotating elements mount a prism within a centre void.

13. The optical beam director of claim 1, wherein the light includes two or more angularly and/or spatially offset light beams.

14. The optical beam director of claim 13, wherein the two or more light beams are each directed by the at least one dispersive component across respective portions of a field of view of the optical beam director.

15. The optical beam director of claim 14, wherein at least two neighbouring respective portions of the field of view overlap with each other.

16. A method in a spatial estimation system, the method comprising directing, by a beam director, light into an environment, the directing comprising spatially directing, by at least one dispersive component, the light in at least one dimension by rotating the at least one dispersive component, wherein the at least one dispersive component includes two prisms and the two prisms are rotated in counter directions, and wherein at least one of the prisms is rotated at a variable rate.

17. A spatial estimation system including a wavelength-tunable light source for generating light and an optical beam director for receiving the directing the generated light, wherein the optical beam director includes at least one dispersive component configured to receive light and to be rotated about a rotational axis for beam steering in at least one dimension, wherein the at least one dispersive component includes two prisms and the optical beam director is configured to rotate the two prisms in counter directions and is configured to rotate at least one of the prisms at a variable rate.

18. The spatial estimation system of claim 17, wherein the wavelength-tunable light source is configured to generate two or more offset light beams.

19. The spatial estimation system of claim 18, wherein the two or more offset light beams are spatially offset along a first dimension of a field of view of the optical beam director.

20. The spatial estimation system of claim 19, wherein the first dimension of the field of view of the optical beam director is created by rotating the dispersive component that is configured to be rotated.
